(19) United States
(12) Patent Application Publication
(10) Pub. No.: US 2006/0045145 A1
(43) Pub. Date: Mar. 2, 2006

(54) Mode-locked laser diode device and wavelength control method for mode-locked laser diode device

(76) Inventor: Shin Arahira, Tokyo (JP)

Correspondence Address: RABIN & Berdo, PC, 1101 14TH STREET, NW, SUITE 500, WASHINGTON, DC, 20005, US

(21) Appl. No.: 11/181,726

(22) Filed: Jul. 15, 2005

(30) Foreign Application Priority Data
Aug. 26, 2004 (JP) 2004-246504

(51) Int. Cl. H01S 3/098

(52) U.S. Cl. 372/18

(57) ABSTRACT

The present invention generates optical pulses of which the wavelength width in the wavelength variable area is sufficiently wide and of which frequency chirping is suppressed enough to be used for optical communication systems.

The present invention is constructed by an optical pulse generation section 101 including MLLD1, CW light source 19, first optical coupling means 110 and second optical coupling means 112. An optical wave guide 30 which includes an optical gain area 3, optical modulation area 2 and a passive wave-guiding area 4 is created in the MLLD. Constant current is injected into the optical gain area from the first current source 11 via the p-side electrode 9 and the n-side common electrode 7. Reverse bias voltage is applied to the optical modulation area 2 by a voltage source 12 via the p-side electrode 8 and the n-side common electrode. The modulation voltage with a frequency obtained by multiplying the cyclic frequency of the resonator of the MLLD by a natural number is applied to the optical modulation area by a modulation voltage source 13. The output light of the CW light source is input to the optical wave guide of the MLLD via the first optical coupling means, and the output light of the MLLD is output to the outside via the second optical coupling means.

### BACKGROUND OF THE INVENTION

1. Field of the Invention

The present invention relates to a mode-locked laser diode (MLLD) device and a wavelength control method for the MLLD device, for generating an ultra short optical pulse string having high repeat frequency using a mode-locking method.

2. Description of Related Art

Ultra short optical pulse generation technology using a laser diode and optical fiber laser is attracting attention as an important technology for increasing the speed and capacity of optical fiber communication based on an optical time-division multiplex method. As the speed of optical fiber communication increases, an optical pulse light source which can generate optical pulses at a shorter cycle period is required. At the same time, the high quality of an optical pulse string to be generated, such as having suppressed frequency chirping and low phase noise, is also important for optical fiber communication.

In the above description, an optical pulse string refers to a string of optical pulses which line up on a time axis at an equal interval, but an optical pulse string may simply be referred to as an optical pulse that is within the scope where confusion is absent.

In terms of generating an optical pulse string where frequency chirping is suppressed and phase noise is low, a mode-locking method is effective as a method for generating optical pulses with a GHz level or higher cyclic frequency. Thus far the mode-locking method has been implemented using an optical fiber laser or a laser diode.

On the other hand, in order to meet the demand for increasing the capacity of communication by a wavelength-division multiplex system, it is important to make the wavelength of the optical pulse to be output from an MLLD variable. The variable wavelength range to be implemented is limited by the gain bandwidth of the optical gain medium and the variable wavelength area of the optical wavelength filter, and by the diffraction grating to be used for controlling the oscillation wavelength.

For an optical pulse light source to be used for optical communication, it is demanded to suppress the frequency chirping of the optical pulses to be output, as described above. Suppressing the frequency chirping of the optical pulses to be generated while implementing the laser oscillation operation in mode-locked status throughout the entire gain bandwidth of the optical gain medium requires a very advanced technology.

Therefore a mode-locked laser to be used for optical communication generally has a configuration in which a wavelength filter and diffraction grating are inserted into the laser resonator to suppress the frequency chirping of the optical pulses to be output, and a part of the gain bandwidth of the gain medium is selectively used. In the case of the mode-locked laser with this configuration, the wavelength variable band thereof is limited to the variable range of the transmission or the diffraction center wavelength of the inserted wavelength filter and diffractive grating. In other words, the wavelength variable band of the mode-locked laser is limited to the variable range of the transmission or diffraction center wavelength by a mechanical means or electrical means of the wavelength filter and diffraction grating inserted into the laser resonator.

A plurality of examples of changing the wavelength of optical pulses acquired from a mode-locked laser by changing the transmission or diffraction center wavelength of the wavelength filter and diffraction grating have been reported (e.g. see H. Takara, S. Kawanishi and M. Saruwatari: “20 GHZ transform-limited optical pulse generation and bit-error-free operation using a tunable actively modelocked Er-doped fiber ring laser”, Electron. Lett., Vol. 29, pp. 1149-1150, June 1993 (non-patent document 1), D. M. Bird, R. M. Fatah, M. K. Cox, P. D. Constantine, J. C. Regnault and K. H. Cameron: “Miniature packaged actively mode-locked semiconductor laser with tunable 20 ps transform limited pulses”, Electron. Lett., Vol. 26, pp. 2086-2087, December 1990 (non-patent document 2), and R. Ludwig and A. Ehrhardt, “Turn-key-ready wavelength, repetition rate and pulsewidth-tunable femtosecond hybrid mode locked semiconductor laser”, Electron. Lett., Vol. 31, pp. 1165-1167, July 1995 (non-patent document 3)).

The first example reported is an example which succeeded to generate wavelength variable optical pulses using an optical fiber type mode-locked laser (e.g. see non-patent document 1). In this example, wavelength control is implemented throughout a 7 nm wavelength width. Recently in a commercial optical fiber type mode-locked laser having a similar structure, wavelength control throughout a 30 nm wavelength width was implemented.

The second example reported is an example which implemented wavelength control throughout a 40 nm wavelength width using an external resonator type MLLD (e.g. see non-patent document 2), and the third example reported is an example which implemented wavelength control throughout a 120 nm wavelength width (e.g. see non-patent document 3).

The optical pulse generation devices implemented by the wavelength variable mode-locked lasers disclosed in the above mentioned non-patent documents 1 to 3 use an optical fiber laser or an external resonator type laser diode of which the sizes are large. The problems of these optical pulse generation devices are that the sizes thereof are large and are mechanically unstable because of the large sizes. In other words, the device is warped by the mechanical force, which fluctuates the time waveform shape of the optical pulse to be generated and cyclic frequency of the optical pulse, and this makes operation unstable.

The fluctuation of the time waveform of the optical pulse and cyclic frequency of the optical pulse to be generated can be prevented by feedback using a feedback circuit, but integrating such a feedback circuit into the device increases the manufacturing cost, and also increases the power consumption of the device. In other words, in terms of practicality, constructing a mode-locked laser device using an optical fiber laser and external resonator type diode is a poor idea.

Therefore it is preferable in terms of practicality to construct a mode-locked laser, which has wavelength control characteristics equivalent to a mode-locked laser comprised of an optical fiber laser or an external resonator type laser diode, using an integrated MLLD, which is mechanically stable and can decrease the cost and power consumption.

There are two methods which have been used to implement wavelength control in an MLLD. The first method is changing the temperature of the laser active medium. The oscillation wavelength of a Fabry-Perot (FP) resonator type laser diode is generally determined by the temperature change characteristic of the gain peak wavelength, and the change amount thereof is about 1 nm/° C. The oscillation wavelength of a laser diode comprising a distributed Bragg reflector (DBR) is generally determined by the temperature change characteristic of the refractive index of the portion constituting the DBR, and the wavelength change amount thereof is about 0.1 nm/° C. The DBR laser diode has a resonator constructed by a Bragg reflector, and the Bragg reflector functions as a type of wavelength filter.

There is an example which implemented wavelength control of the optical pulses to be oscillated by changing the element temperature of a laser diode by an FP resonator type MLLD device comprising an FP resonator type laser diode (e.g. see M. C. Wu, Y. K. Chen, T. Tanbun-Ek, R. A. Logan and M. A. Chin, “Tunable monolithic colliding pulse mode-locked quantum-well lasers”, IEEE Photon. Technol. Lett., Vol. 3, pp. 874-876, October 1991 (non-patent document 4)).

However handling an FP resonator type MLLD device is difficult since the frequency chirping of the optical pulses to be output cannot be suppressed, as described above, and this frequency chirping strongly depends on the driving conditions of the MLLD. Generally increasing the gain current to be supplied to the MLLD increases the frequency chirping (e.g. see S. Arahira, Y. Katoh and Y. Ogawa, “20 GHz sub-picosecond monolithic modelocked laser diode”, Electron. Lett., Vol. 36, pp. 454-456, March 2000 (non-patent document 5)). In order to suppress the frequency chirping, the gain current to be supplied to the MLLD is decreased, but the power of the optical pulses to be output drops. In this case, the relative intensity noise (RIN) also increases. In any case, the FP resonator type MLLD device is not appropriate to be integrated into an optical communication system.

The second method is changing the wavelength of the optical pulses to be generated by the DBR type MLLD by controlling the Bragg wavelength of the DBR in the DBR type MLLD device comprising the DBR type laser diode, based on a control signal from the outside. With this method, the frequency chirping of the optical pulses to be output is suppressed using the phenomena that the wavelength of light to be oscillated is limited by the wavelength selection function of the DBR. Therefore the DBR type MLLD can generate optical pulses of which frequency chirping is suppressed, which can be used in an optical communication system.

Electric signals are used as control signals which are input to the DBR from the outside to change the Bragg wavelength of the DBR. For example, it is reported that the DBR is created in the p-i junction of the p-i-n junction, and the Bragg wavelength is changed by changing the effective refractive index of the DBR by the plasma effect generated when current is supplied to the p-i-n junction (e.g. see H. F. Liu, S. Arahira, T. Kunii and Y. Ogawa, “Tuning characteristics of monolithic passively mode-locked distributed Bragg reflector semiconductor lasers”, IEEE. J. Quantum Electron., Vol. 32, pp. 1965-1975, Nov. 1996 (non-patent document 6) This example is reported as element A in the non-patent document 6). Another example reported is that a platinum thin film, which functions as an electric resistor, is formed on the upper part of the DBR, current is supplied to this electric resistor, and the Bragg wavelength is changed by using the temperature change of the DBR by the Joule heat generated as a result (e.g. see the non-patent document 6. This example is reported as element B in the non-patent document 6).

There is also an invention disclosed wherein optical injection locking is implemented by injecting CW light, which is output from an external light source, into a laser which generates optical pulses (e.g. see L. G. Joneckis, P. T. Ho and G. L. Burdge, “CW injection seeding of a modelocked semiconductor laser”, IEEE J. Quantum Electron., Vol. 27, pp. 1854-1858, July 1991 (non-patent document 7), and Y. Matsui, S. Kutsuzawa, S. Arahira and Y. Ogawa, “Generation of wavelength tunable gain-switched pulses from FP MQW lasers with external injection seeding”, IEEE Photon. Technol. Lett., Vol. 9, pp. 1087-1089, August 1997 (non-patent document 8)).

In the above mentioned non-patent document 7, an example using an external resonator type laser as the laser to generate optical pulses is disclosed. Since an external resonator type laser is used, it is difficult to implement compactness and to secure stability of operation. Also using an external resonator type laser tends to cause various problems due to the positional deviation of the optical system, such as the change of mode-locking characteristics and the appearance of composite resonator modes caused by the change of the ambient temperature. The change of the ambient temperature also tends to cause such problems as a deviation from the frequency tuning range due to the change of the rotation frequency of the optical resonator.

In the non-patent document 8, on the other hand, an example of using a gain switch type laser as the laser for generating optical pulses is disclosed. Since a gain switch type laser is used, suppressing the time jitter and the frequency chirping of optical pulses has limitations.

For the width of the wavelength variable area implemented by the above mentioned DBR type MLLD, the DBR type MLLD reported as element A in non-patent document 6 has about a 4 nm wavelength width, and the DBR type MLLD reported as element B in non-patent document 6 has about a 9 nm wavelength width. These values are about 1/10 that of the MLLD device that uses the optical fiber laser disclosed in non-patent document 1, or the external resonator type laser diode disclosed in non-patent documents 2 and 3.

With the foregoing in view, it is an object of the present invention to provide an optical pulse generation light source which can sufficiently implement compactness and stable operation of an MLLD device and still have a sufficiently wide wavelength width of the wavelength variable area, and can generate optical pulses with the frequency chirping suppressed enough to be used for optical communication systems.

### SUMMARY OF THE INVENTION

To achieve this object, the MLLD device of the present invention comprises an MLLD, a continuous wave light output light source, first optical coupling means and second optical coupling means.

The MLLD further comprises an optical wave guide where an optical gain area in which a population inversion is created, and an optical modulation area having a function to modulate the light intensity are included, and the optical gain area and optical modulation area are laid out in series.

The continuous wave light output light source generates continuous wave lights with a wavelength close to the wavelength of one longitudinal mode out of the oscillation longitudinal modes of the MLLD. The wavelength of one longitudinal mode out of the oscillation longitudinal modes of the MLLD and the wavelength of the continuous wave light which is output by the continuous wave light output light source must be close to each other in a range where the MLLD can generate an optical injection locking phenomena. Hereafter the continuous wave light may be referred to as the CW (Continuous Wave) light and the light source which outputs the CW light may be referred to as the CW light source.

The first optical coupling means inputs the output light of the CW light source to the optical wave guide of the MLLD, and comprises a polarization plane adjustment element for controlling the polarization direction of the output light of the CW light source so that the polarization direction of the output light source of the CW light source in the optical wave guide of the MLLD matches the polarization direction of the oscillation light of the MLLD. The second optical coupling means is installed for outputting the optical pulses, which are output by the MLLD, to the outside.

To achieve the above object, the wavelength control method for the MLLD device according to the present invention comprises the following steps (A) to (F) in order to control the wavelength of the optical pulses to be acquired by the above mentioned MLLD device.

(A) A step of oscillating the MLLD,

(B) a step of implementing the mode-locking operation of the MLLD by performing optical modulation at a frequency obtained by multiplying a cyclic frequency of a resonator of the MLLD by a natural number in the optical modulation area,

(C) a step of outputting a CW light with a wavelength close to the wavelength of one longitudinal mode out of the oscillation longitudinal modes of the MLLD from the CW light source,

(D) a step of adjusting the polarization direction of the output light of the CW light source by a polarization plane adjustment element so that the polarization direction of the output light of the CW light source in the optical wave guide of the MLLD matches the polarization direction of the oscillation light of the MLLD, and inputting the output light to the optical wave guide of the MLLD,

(E) a step of adjusting the intensity of the CW light to be input to the optical wave guide of the MLLD from the CW light source so that the mode-locked optical pulses, of which the wavelength is the same as that of the output light of the CW light source, of which the frequency chirping is suppressed, and of which phase noise is low, are output from the MLLD, and

(F) a step of outputting the optical pulses from the MLLD.

Here the wavelength of one longitudinal mode of the oscillation longitudinal modes of the MLLD and the wavelength of the CW light to be output by the CW light source are close to each other in a range where the MLLD can generate the optical injection locking phenomena.

The MLLD device further comprises an MLLD further comprising the optical wave guide where the optical gain area in which population inversion is created and the optical modulation area having a function to modulate the light intensity are included, and the optical gain area and the optical modulation area are laid out in series, so the mode-locking operation can be implemented in this MLLD.

The MLLD device also comprises the CW light source and the first optical coupling means, so CW light with a wavelength close to the wavelength of one longitudinal mode out of the oscillation longitudinal modes of the MLLD, which is in mode-locking operation, is output from the CW light source, and this CW light can be input to the optical wave guide of the MLLD via the first optical coupling means. And the CW light source has a function to generate continuous wave light with a wavelength close to the wavelength of one longitudinal mode out of the oscillation longitudinal modes of the MLLD in a range where the MLLD can generate the optical injection locking phenomena.

The first optical coupling means comprises a polarization plane adjustment element for controlling the polarization direction of the output light of the CW light source, so in the optical wave guide of the MLLD, adjustment can be made so that the polarization direction of the output light of the CW light source matches the polarization direction of the oscillation light of the MLLD. In other words, by the first optical coupling means, adjustment can be made in the optical wave guide of the MLLD, so that the polarization direction of the output light of the CW light source matches the polarization direction of the oscillation light of the MLLD, and the output light of the CW light source can be input to the optical wave guide of the MLLD.

The CW light with the wavelength, which is close to the wavelength of one longitudinal mode out of the oscillation longitudinal modes of the MLLD which is in mode-locking operation, can be matched with the polarization direction of the oscillation light of the MLLD and input to the optical wave guide of the MLLD, so the optical injection locking phenomena can be generated in the MLLD.

Detailed description will be given later, but if the intensity of the CW light to be input to the optical wave guide of the MLLD is weak, optical injection locking has very little effect. If the light intensity of the CW light is too strong, the oscillation light to be output from the MLLD is completely fixed to the wavelength of the CW light to be input, and generates a CW oscillation in that state, so the mode-locking operation is diminished. Therefore as confirmed by experience, if the CW light of which the intensity is at a level which is sufficient to implement the effect of the optical injection locking and which does not diminish the mode-locking operation, optical pulses of which the wavelength width in the wavelength variable area is sufficiently wide and of which frequency chirping is suppressed can be acquired.

The above mentioned optical pulses, in which the optical injection locking is implemented and of which frequency chirping to be output from the MLLD is suppressed, can be output by the MLLD to the outside using the second optical coupling means.

The MLLD device according to the present invention uses an MLLD comprising an optical wave guide where the optical gain area in which population inversion is created and the optical modulation area having a function to modulate light intensity are included, and the optical gain area and the optical modulation area are laid out in series, and an optical fiber laser or an external resonator type laser diode, of which the sizes are large, are not used, so compactness and stable operation can be sufficiently implemented.

By executing the wavelength control method for the MLLD device according to the present invention comprising the steps (A) to (F), optical pulses with a desired wavelength can be acquired from the MLLD device of the present invention.

(A) The step of oscillating the MLLD can be implemented by supplying the current in the forward direction in the optical gain area of the MLLD, and performing carrier injection.

(B) Performing optical modulation at a frequency, obtained by multiplying a cyclic frequency of the resonator of the MLLD by a natural number, in the optical modulation area can be implemented by applying an AC voltage equivalent to the frequency, obtained by multiplying a cyclic frequency of the resonator of the MLLD by a natural number, in the optical modulation area using the modulation voltage source, so the step of implementing the mode-locking of the MLLD can be implemented.

(C) Outputting the CW light with a wavelength close to the wavelength of one longitudinal mode out of the oscillation longitudinal modes of the MLLD from the CW light source can be implemented by CW-operating the laser diode having a light with this wavelength in its oscillation wavelength band.

(D) Adjusting the polarization direction of the output light of the CW light source so that the polarization direction of the output light of the CW light source matches the polarization direction of the oscillation light of the MLLD in the optical wave guide in the MLLD can be executed by using a polarization plane adjustment element, such as a wave plate. Inputting the output light of which the polarization direction was adjusted to the optical guide of the MLLD can be executed by the first optical coupling means.

(E) In the step of adjusting the intensity of the CW light to be input to the optical wave guide of the MLLD from the CW light source so that mode-locked optical pulses, of which the wavelength is the same as that of the output light of the CW light source and of which frequency chirping is suppressed and phase noise is low, are output from the MLLD, and the drive current of the CW light source is adjusted.

(F) The step of outputting the optical pulses from the MLLD can be executed by the second optical coupling means.

According to the wavelength control method for the output optical pulses of the MLLD device described above, -the MLLD performs mode-locking operation in steps (A) and (B), and the CW light of which the intensity of the CW light is at a level where the effect of optical injection locking is sufficiently expressed and the mode-locking operation does not diminish, is input to the optical wave guide of the MLLD in steps (C), (D) and (E), so optical pulses, of which the wavelength width in the wavelength variable area is sufficiently wide and of which frequency chirping is suppressed, can be acquired.

### BRIEF DESCRIPTION OF THE DRAWINGS

The foregoings and other objects, features and advantageous of the present invention will be better understood from the following description taken in connection with the accompanying drawings, in which:

FIG. 1 is a diagram depicting a general configuration of the wavelength variable MLLD of the first embodiment;

FIG. 2 are diagrams depicting the operation of the wavelength variable MLLD of the first embodiment;

FIG. 3 are graphs depicting the change of the photo-spectrum of the MLLD output light by a CW light injection from the outside;

FIG. 4 is a graph depicting the intensity dependency of the CW light to be input to the MLLD with respect to the light pulse width and time bandwidth product;

FIG. 5 is a graph depicting the CW light injection intensity dependency of the optical gain spectrum of the MLLD;

FIG. 6 are graphs depicting the relationship between the light pulse width and time bandwidth product, the time jitter and relative intensity noise, and the output optical pulse intensity from MLLD and input CW light intensity to MLLD, with respect to the CW light wavelength to be input to MLLD;

FIG. 7 are graphs depicting the element temperature dependency of the light pulse width to be output from MLLD and output intensity;

FIG. 8 is a diagram depicting a general configuration of the wavelength variable MLLD of the second embodiment;

FIG. 9 is a diagram depicting the change of the position of the longitudinal mode;

FIG. 10 is a graph depicting the dependency of full width at half maximum of the optical pulse on the current to be injected into the passive wave-guiding area;

FIG. 11 is a diagram depicting a general configuration of the wavelength variable MLLD of the third embodiment;

FIG. 12 is a diagram depicting a general configuration of the wavelength variable MLLD of the fourth embodiment; and

FIG. 13 is a diagram depicting a general configuration of the wavelength variable MLLD of the fifth embodiment.

### DESCRIPTION OF THE PREFERRED EMBODIMENTS

Embodiments of the present invention will now be described with reference to the drawings. The configuration diagram illustrates an example of the present invention, where the positional relationship of each composing element is shown merely to assist in understanding the present invention, and the present invention is not limited to the embodiments. In the following description, specific equipment or conditions are merely examples of preferred embodiments, and shall not limit the present invention. For the same composing elements similar in each drawing, redundant description thereof may be omitted.

### First Embodiment

(Configuration)

The configuration of the wavelength variable MLLD of the first embodiment of the present invention will be described with reference to FIG. 1. The MLLD device of the first embodiment comprises an MLLD 1, CW light source 19, first optical coupling means 110 and second optical coupling means 112. And the optical pulse generation section 101 is constructed including the MLLD 1.

The MLLD 1 further comprises an optical guide 30 where the optical gain area 3, in which population inversion is created, and the optical modulation area 2 having a function to modulate the light intensity and passive wave-guiding area 4, are laid out in series, and this optical wave guide 30 propagates the oscillation light. The passive wave-guiding area 4 is made of transparent material which oscillation light of the MLLD 1 transmits through. In the first embodiment, the optical wave guide 30 created in the MLLD 1 is comprised of three areas: the optical gain area 3, optical modulation area 2 and passive wave-guiding area 4.

The optical gain area 3, optical modulation area 2 and passive wave-guiding area 4 of the optical wave guide 30 are integrated as one optical wave guide, and no clear boundaries of these three areas exist. The optical gain area 3 is an area where current is injected for creating population inversion, and the optical modulation area 2 is an area of which transmittance is modulated from the outside. Also as described later, the passive wave-guiding area 4 is an area of which the effective refractive index is adjusted from the outside.

In other words, the optical modulation area 2 has an optical modulation function required for mode locking, that-is an area which plays a role of a saturable absorption band of the passive mode-locked laser or an optical modulator, such as an electroabsorption type optical modulator of the active mode-locked laser. This area (optical modulation area 2) is also called a mode locker. The optical gain area 3 is an area having an optical amplification function to cause laser oscillation, and is constructed using a semiconductor laser diode. In the MLLD 1 of the present invention, the population inversion is created by injecting current into the photo-active area, which is constructed including the p-n-junction, to implement the light amplification function. The passive wave-guiding area 4 is an optical wave guide made of transparent material which light with a wavelength of the laser oscillation light of the MLLD 1 transmits through.

In this first embodiment, as well as in the example of the second and later embodiments, MLLD 1 comprising the optical wave guide 30 further comprising three areas: optical gain area 3, optical modulation area 2 and passive wave-guiding area 4, is used, but the MLLD is not limited to the MLLD 1 comprising the optical wave guide 30 further comprising these three areas, but the present invention can also be embodied by using an MLLD where an optical gain-area is created at two or more locations, or an MLLD which has no passive wave-guiding area, or an MLLD which has only the optical gain area which also functions as the optical modulation area by applying the modulation voltage to the optical gain area.

In other words, it is not essential that the optical wave guide 30 set in the MLLD 1 is comprised of three areas: the optical gain area 3, optical modulation area 2 and passive wave-guiding area 4. Only if the MLLD has such a structure that laser oscillation is possible by current injection excitation, and that mode locking can be implemented by performing optical modulation at a frequency obtained by multiplying the cyclic frequency of the resonator of the MLLD by a natural number, an MLLD with any structure can be used.

The basic structure of the MLLD 1 is a semiconductor laser diode structure where current is injected into the photo-active area constructed including a p-n junction, and population inversion is created so as to implement laser oscillation. In the MLLD 1 shown in FIG. 1, the optical wave guide 30 comprised of three areas: the optical gain area 3, optical modulation area 2 and passive wave-guiding area 4, is inserted between the p-type clad layer 5 and the n-type clad layer 6. Certainly a semiconductor laser diode comprised of an n-type clad layer instead of a p-type clad layer 5, and a p-type clad layer instead of an n-type clad layer 6 may be used, and this is simply a design issue. In this description, an MLLD may have a structure of an optical wave guide 30, comprised of three areas, inserted between the p-type clad layer 5 and the n-type clad layer 6, is used.

In the optical gain area 3, constant current is injected from the first current source 11 via the p-side electrode 9 and the n-side common electrode 7, and as a result the population inversion required for laser oscillation is created in the optical gain area 3. Also reverse bias voltage is applied to the optical modulation area 2 by the voltage source 12 via the p-side electrode 8 and the n-side common electrode 7. Also modulation voltage with a frequency obtained by multiplying a cyclical frequency of the resonator of the MLLD by a natural number is applied by the modulation voltage source 13. By setting the current value or voltage value of the first current source 11, voltage source 12 and modulation voltage source 13 so as to satisfy predetermined conditions, the mode locking operation of the MLLD 1 can be implemented.

The MLLD 1 is temperature controlled so as to operate at a predetermined temperature by a temperature monitor 15, an exothermic/endothermic element 14, which performs exothermic and endothermic operations for a Pelletier element, for example, and an exothermic/endothermic element controller 16.

The CW light source 19 is a light source for outputting a CW light with a single wavelength provided outside the MLLD 1. The output light of the CW light source 19 is input to the optical wave guide 30 of the MLLD 1 via the first optical coupling means 110. In the following description, “inputting the CW light to the optical wave guide 30 of the MLLD 1” may be expressed as “injecting CW light into the MLLD 1”.

The first optical coupling means 110 is installed for adjusting the output light of the CW light source so that the polarization direction thereof matches the polarization direction of the oscillation light of the MLLD 1 in the optical wave guide 30 of the MLLD 1, and inputting the output light into the optical wave guide 30 of the MLLD 1, and is comprised of a polarization plane adjustment element 20, first optical isolator 21, optical circulator 18 and coupling lens 17.

The output light of the MLLD 1 is output to the outside via the second optical coupling means 112. In other words, the second optical coupling means 112 is installed to output the output optical pulses of the MLLD 1 to the outside, and is comprised of a coupling lens 17, optical circulator 18 and second optical isolator 22.

The optical pulse generation section 101 is an area for generating optical pulses with a desired wavelength, and is comprised of the MLLD 1, first current source 11, voltage source 12, modulation voltage source 13, exothermic/endothermic element 14, temperature monitor 15 and exothermic/endothermic element controller 16.

(Operation)

The optical injection locking will be described with reference to FIG. 2(A) and FIG. 2(B). FIG. 2(A) and FIG. 2(B) show the oscillation spectrum of the MLLD 1 where the abscissa is the light frequency and the ordinate is the light intensity, both in an arbitrary scale. The straight lines lined up with an interval of the modal frequency indicates the longitudinal modes of the oscillation spectrum. The half width of each longitudinal mode of the oscillation spectrum is extremely narrow, so these half-widths are ignored here.

FIG. 2(A) shows the oscillation spectrum of the MLLD 1, which is in mode-locking operation, and FIG. 2(B) shows the oscillation spectrum of the MLLD 1 when the output light is input from the CW light source with frequency fcw (=c/λcw) to the optical wave guide 30 of the MLLD 1, and optical injection locking occurs. Here c is the speed of light and λcw is a wavelength of the output light from the CW light source. Since optical injection locking occurs, the peak frequency of the output optical pluses of the MLLD 1 is the same as the frequency fcw of the CW light which was input. The peak frequency of the output optical pulses of the MLLD 1 refers to the frequency of a longitudinal mode having the highest intensity out of the longitudinal modes of the oscillation spectrum of the output optical pulses of the MLLD 1, as shown in FIG. 2(B).

In the following description, the CW light source or the output optical pulse may be specified by the wavelength or frequency, but wavelength and frequency have the relationship of (frequency)=(speed of light)/(wavelength), so the physical values of the CW light source or output optical pulses are the same whether specified by the wavelength or frequency. Therefore no special significance is given whether the specification is by wavelength or frequency. For example, the physical significance of the expressions of a wavelength variable or frequency variable are the same.

As FIG. 2(A) and FIG. 2(B) show, the peak frequency of the oscillation spectrum of the output optical pulses of the MLLD 1 exists at a different position from the frequency fcw before optical injection locking occurs. However once optical injection locking occurs by the output light being input from the CW light source with frequency fcw (=c/λcw) to the optical wave guide 30 of the MLLD 1, the longitudinal mode with a frequency the same as frequency fcw of the output light from the CW light source has the highest intensity. In other words, by injecting CW light with a frequency the same as the desired frequency into the MLLD 1, which is in mode locking operation, to acquire optical pulses with the desired frequency, the MLLD 1 can be controlled so that the frequency of optical pulses to be output from the MLLD 1 become the same as the desired frequency.

At this time the polarization direction of the CW light to be input to the optical wave guide 30 of the MLLD 1 in the optical wave guide 30 must match the polarization direction of the laser light to be generated in the optical wave guide 30 of the MLLD 1. The polarization plane adjustment element 20 is installed in the first optical coupling means 110 for this purpose. The polarization plane adjustment element 20 can be constructed using a half wave plate, for example, and can freely rotate the polarization plane of the output light of the CW light source 19. For example, by rotating the crystal axis (phase advancement axis or phase delay axis) of the half wave plate, the polarization plane of the output light of the CW light source 19 is rotated, so that the polarization direction of the CW light, which is input to the optical wave guide 30 of the MLLD 1, in the optical wave guide 30 of the MLLD 1 and the polarization direction of the laser light which is generated in the optical wave guide 30 of the MLLD 1, can be matched.

The optical isolators 21 and 22 are installed in the first optical coupling means 110 and the second optical coupling means 112 respectively to block the reflected return light. The output light of the CW light source, of which polarization plane is adjusted by the polarization plane adjustment element 20, passes through the optical isolator 21 and is input to the optical wave guide 30 of the MLLD 1 via the optical circulator 18 and the coupling lens 17. The optical pulses which are output from the optical wave guide 30 of the MLLD 1 pass through the optical isolator 22 and are output to the outside via the coupling lens 17 and the optical circulator 18.

As described above, the MLLD device according to the first embodiment of the present invention is an MLLD device wherein the output light from the CW light source 19, for generating the CW light for controlling the frequency of optical pulses generated by the optical pulse generation section 101, is input to the optical pulse generation section 101 via the first optical coupling means 110, and the optical pulses having a desired frequency generated by the optical pulse generation section 101 are output to the outside via the second optical coupling means 112.

The optical isolators 21 and 22 need not always be installed in the first optical coupling means 110 and second optical coupling means 112 respectively. This installation is unnecessary if there are no such reasons as the mode-locking operation of the MLLD 1 becoming unstable unless the reflected return light is blocked, or if there are problems being generated to an external device which uses the optical pulses generated by the optical pulse generation section 101. If the first optical coupling means 110 and second optical coupling means 112 are comprised of optical systems that conserve the polarization status of light, such as the case of a polarization plane conserving optical fiber, then installation of the polarization plane adjustment element 20 is not always necessary.

If the intensity of the CW light to be injected into the MLLD 1 is weak, then optical injection locking has very little effect. In other words, by the optical injection locking, the frequency chirping amount of the optical pulses to be output from the MLLD 1 decreases, and the intensity waveform on the time axis of the optical pulses is improved to be a preferable form, but if the intensity of the CW light to be injected into the MLLD 1 is weak, the frequency chirping amount hardly decreases compared with the case when CW light is not input.

If the intensity of the CW light to be injected into the MLLD 1 is too high, then the oscillation frequency of the MLLD 1 is completely locked into the frequency of the CW light to be injected into the MLLD 1. As a result, the MLLD 1 starts CW oscillation at a single frequency, and the mode-locking operation itself diminishes.

Therefore by adjusting the intensity of the CW light to be injected into the MLLD 1 to be an intensity in a range that is not too low or too high, the MLLD 1 can be controlled so as to output optical pulses of which frequency chirping is suppressed while maintaining the mode-locking operation. This was confirmed by experiment, so the results of this experiment will now be presented, and the effect of the present invention will be described.

The optical modulation area 2 integrated into the optical wave guide 30 of the MLLD 1 shown in FIG. 1 has a structure to function as a field absorption type optical modulator. The optical gain area 3 integrated into the optical wave guide 30 is a distorted quantum well of which the quantum well is constructed by InGaAsP with a 0.6% compressive distortion factor, and the barrier is constructed by InGaAsP without distortion.

The band gap wavelength of the multiple quantum well structure is 1.562 μm. The optical modulation area 2 and the passive wave-guiding area 4 are formed with InGaAsP of which the band gap wavelength is 1.48 μm. The element length of the MLLD 1 is 1050 μm, and the cyclic frequency of the resonator is about 40 GHz.

In order to function as the exothermic/endothermic element 14, a Pelletier element was installed contacting the electrically insulated n-side common electrode 7 of the MLLD 1. And a temperature monitor 15, for measuring the temperature of the MLLD 1, was installed.

To implement the mode-locking operation, a sinusoidal voltage, with a 39.81312 GHz frequency and 25 dBm RF (Radio Frequency) wave intensity, was applied to the optical modulation area 2 by the modulation voltage source 13. The current which was injected into the optical gain area 3 by the first current source 11 was 83 mA. The DC bias voltage applied to the optical modulation area 2 by the voltage source 12 was −0.52 V.

The temperature of the MLLD 1, measured by the temperature monitor 15, was set to 20° C., and the full width at half maximum of the mode-locked optical pulses, which are output by the mode-locking operation of the MLLD 1 without injecting the CW light into the MLLD 1, was 3.9 ps. The central wavelength of the spectrum of these mode-locked optical pulses and the spectrum width thereof were 1560.9 nm and 2.2 nm respectively. Moreover, the time bandwidth product was 0.91. This is about three times of 0.315, which is assumed as the Fourier transform limit value. As a result, it became clear that the mode-locked optical pulses, which are output by the mode-locking operation of the MLLD 1 without injecting the CW light into the MLLD 1, have high frequency chirping. The light intensity of the mode-locked optical pulses is 6.1 dBm.

Here the time bandwidth product is a dimensionless quantity given by the product of the full width at half maximum of the intensity waveform on the time axis of optical pulses and the full width at half maximum of the intensity waveform of the time average light spectrum on the frequency axis. The Fourier transform limit value, on the other hand, is a minimum value that the time bandwidth product could have. If the optical pulses have no frequency chirping, then the time bandwidth product has the Fourier transform limit value, so the level of frequency chirping the optical pulses have can be evaluated by measuring the time bandwidth product.

Generally when the optical pulses pass through the optical modulator, frequency chirping is generated to the optical pulses by the phase modulation effect generated there. In other words, one cause of frequency chirping of the mode-locked optical pulses, which are output by the mode-locking operation of the MLLD 1 without injecting the CW light into the MLLD 1, is the phase modulation effect generated in the optical modulation area 2.

The result of observing the changes of the spectrum of the optical pulses which are output from the MLLD 1 caused by injecting the CW light with 1560.9 nm wavelengths into the MLLD 1 will be described with reference to FIGS. 3(A), (B) and (C). In these graphs, the abscissa indicates the wavelength scaled in nm units, and the ordinate indicates the light intensity scaled in dBm units. FIG. 3(A) shows the spectrum of optical pulses to be output from the MLLD 1 in the case when the CW light was not injected, FIG. 3(B) shows the case when the CW light with a −12.6 dBm intensity was injected into the MLLD 1, and FIG. 3(C) shows the case when the CW light with a +1.4 dBm intensity was injected into the MLLD 1.

This shows that as the intensity of the CW light to be injected into the MLLD 1 increases, the full width at half maximum of the envelope of the spectrum of the optical pulses to be output from the MLLD 1 decreases, and the full width at half maximum of the spectrum of the optical pulses to be output when the CW light with a +1.4 dBm intensity is injected into the MLLD 1, shown in FIG. 3(C), (width at the position 3 dB lower than the peak value of the envelope shown by the dotted line) is 0.72 nm, which is about ⅓ compared with the case when the CW light is not injected (FIG. 3(A)). The half widths of the spectrum in FIG. 3(A) and FIG. 3(C) both indicate widths at a portion 3 dB lower than the peak value of the envelope, and the actual values of these half widths are calculated using the actual values of the light intensities shown in FIG. 3(A) and FIG. 3(C).

Now the result of observing the dependency of the optical pulse width and the time band width product on the intensity of the CW light to be input into the MLLD 1 on the time axis of optical pulses to be output from the MLLD 1 will be described with reference to FIG. 4. The abscissa indicates the input intensity of the CW light to the MLLD 1 in dBm units, the ordinate at the left side indicates the full width at half maximum of the optical pulses to be output from the MLLD 1 on the time axis in ps units, and the ordinate at the right side indicates the time bandwidth product. The full width at half maximum of the optical pulses to be output from the MLLD 1 on the -time axis is indicated by ∘, and the time bandwidth product is indicated by ●.

The full width at half maximum of optical pulses on the time axis hardly changed up to the point where the input intensity of the CW light to the MLLD 1 becomes about −5 dB (range indicated by “a” in FIG. 4). On the other hand, the time bandwidth product radically decreased as the input intensity of the CW light to the MLLD 1 increased, and became almost 0.4 at the point where the input intensity of the CW light is −12 dB (position indicated by “b” in FIG. 4). The time bandwidth product 0.4 is close to the Fourier transform limit value 0.351.

In other words, while the input intensity of the CW light to the MLLD 1 is increased until reaching about −5 dB, the effect of injecting the CW light does not appear as a change of the full width at half maximum of the optical pulses on the time axis, but appears as an effect to decrease the time bandwidth product. This means that the effect of suppressing the generation of frequency chirping is dominant while the input intensity of the CW light to the MLLD 1 is increased until reaching about −5 dB, therefore the spread of the spectrum width of optical pulses by frequency chirping can be suppressed in this range.

If the input intensity of the CW light to the MLLD 1 is increased and exceeds −5 dB, on the other hand, the time bandwidth product hardly changes. In the state where the frequency chirping is suppressed, the full width at half maximum of the optical pulses on the time axis spreads. As this experiment result shows, increasing the input intensity of the CW light to exceed −5 dB suppresses the widening of the spectrum width of the optical pulses excessively, and the full width at half maximum of the optical pulses on the time axis spreads. Since a value, that is the full width at half maximum of the optical pulses on the time axis multiplied by the spectrum width of the optical pulses, determines the time bandwidth product, the full width at half maximum of the optical pulses on the time axis becomes wider as the spectrum width of the optical pulses becomes narrower under conditions where the time bandwidth product hardly changes. In other words, excessive suppression of the spread of the spectrum width of the optical pulses decreases the spectrum width excessively, and as a result, the full width at half maximum of the optical pulses on the time axis spreads.

To verify the above experiment result described with reference to FIG. 4 in more detail, the change of the optical gain of the MLLD 1 caused by the injection of the CW light into the MLLD 1 was observed. FIG. 5 shows this observed result. The abscissa in FIG. 5 indicates the wavelength of the light scaled in nm units, and the ordinate indicates the value of the optical gain with respect to the wavelength of the light scaled in dB units. The value of the optical gain here means the optical gain acquired when the light passes through the optical wave guide 30 of the MLLD 1 once in one direction, and is also called single passing gain. Here the wavelength of the CW light which is input to the optical wave guide 30 of the MLLD 1 and which passes through the optical wave guide 30 in one direction is 1558 nm.

FIG. 5 shows the single passing gain when the intensity of the CW light with a 1558 nm wavelength to be input to the optical wave guide 30 of the MLLD 1 was changed as −8 dB, −3 dB and +2 dB, compared with the case of not inputting the CW light. In FIG. 5, the curve indicated as “without injection light”, shows the single passing gain when the CW light is not input.

When the intensity of the CW light to be input to the optical wave guide 30 of the MLLD 1 is increased as −8 dB, −3 dB and +2 dB, the curve to indicate the single passing gain corresponding to the respective intensity is shown at lower positions in FIG. 5 in this sequence accordingly. In other words, the injection of the CW light decreases the optical gain. This is probably because the injection of the CW light increases the stimulated emission between the energy levels corresponding to the wavelength of the CW light, and decreases the carrier density. If the optical gain decreases, the number of modes for oscillating lasers by sequentially reaching the threshold gain from both ends of the optical gain band decreases, so the spread of the spectrum of the optical pulses to be output from the MLLD 1 decreases. As a result the frequency chirping is suppressed.

The above described experiment results showed that injecting CW light into the MLLD 1 can generate optical pulses of which frequency chirping is suppressed. The above mentioned phenomena of decreasing the spread of the spectrum of optical pulses caused by the injection of CW light appears even if the wavelength of the CW light to be injected deviates from the center wavelength of the oscillation spectrum of the MLLD 1. On the other hand, the wavelength of the optical pulses to be output from the MLLD 1 in a state where the CW light being injected is controlled by the waveform of this injected CW light. Therefore the wavelength of the output optical pulses of the MLLD 1 can be controlled according to the wavelength of the CW light to be injected, and an MLLD device that solves the above mentioned problem can be implemented.

The result of measuring the characteristics of the output optical pulses of the MLLD 1 with respect to the change of the wavelength of the CW light to be injected into the MLLD 1 will be described with reference to FIGS. 6(A), (B) and (C). In FIG. 6(A), (B) and (C), the abscissa indicates the wavelength of the CW light scaled in nm units.

FIG. 6(A) shows the full width at half maximum of the output optical pulses on the time axis and the time bandwidth product with respect to the wavelength of the CW light to be injected into the MLLD 1. The ordinate at the left side of FIG. 6(A) indicates the full width at half maximum of the output optical pulses on the time axis scaled in ps units, and the ordinate at the right side indicates the time bandwidth product. In FIG. 6(A), the full width at half maximum of the output optical pulses on the time axis is indicated by ∘, and the time bandwidth product is indicated by ●.

FIG. 6(B) shows the time jitter and RIN with respect to the wavelength of the CW light to be injected into the MLLD 1. The ordinate at the left side of FIG. 6(B) indicates the time jitter scaled in ps units, and the ordinate at the right side indicates the RIN scaled in dB/Hz units. In FIG. 6(B), the time jitter is indicated by ∘, and the RIN is indicated by ●.

FIG. 6(C) shows the intensity of the output optical pulses of the MLLD 1 and the input intensity of the CW light to the MLLD 1 required for implementing optical injection locking operation, with respect to the wavelength of the CW light to be injected into the MLLD 1. The ordinate at the left side in FIG. 6(C) indicates the intensity of the output optical pluses of MLLD 1 scaled in dBm units, and the ordinate at the right side indicates the input intensity of the CW light to the MLLD 1 scaled in dBm units. In FIG. 6(C), the intensity of the output optical pulses of the MLLD 1 is indicated by ∘, and the input intensity of the CW light to the MLLD 1 is indicated by ●.

In FIG. 6(A), the full width at half maximum of the output optical pulses on the time axis is a minimum of 2.9 ps and a maximum of 3.9 ps in the 22 nm range of a light wavelength between 1546 nm and 1568 nm, so the full width at half maximum of the output optical pulses on the time axis has changed 1 ps. Within the same light wavelength range, the time bandwidth product is a minimum of 0.34 and a maximum of 0.48, so as FIG. 6(A) shows, the optical pulses, of which full width at half maximum on the time axis is narrow enough and of which frequency chirping is small enough to be acceptable for an optical communication system, can be acquired.

FIG. 6(B) shows that the time jitter is about 0.18 ps. This value is about the same as the time jitter of the modulation voltage source 13, so the optical pulses, of which the time jitter is sufficiently low, can be acquired. RIN is −130 dB/Hz at the maximum, so in terms of RIN as well, optical pulses, of which the noise is low enough to be acceptable for an optical communication system, can be acquired.

As FIG. 6(C) shows, the intensity of the output optical pulses of the MLLD 1 is a minimum of 3.2 dBm and a maximum of 5.2 dBm, so the fluctuation of the intensity of the optical output pulses is within 2 dB. This value is also small enough to be acceptable for an optical communication system. The input intensity of the CW light to the MLLD 1, which is required for implementing the optical injection locking operations, increases at both ends, the short wavelength side and the long wavelength side, in the measured wavelength range of the CW light, but this value is a maximum of 2.0 dBm, which is smaller than the minimum value of 2.5 dBm of the output intensity of the MLLD 1. In other words, the intensity of the optical pulses to be output increases more than the CW light to be injected into the MLLD 1, therefore an amplification effect can be acquired in the MLLD 1.

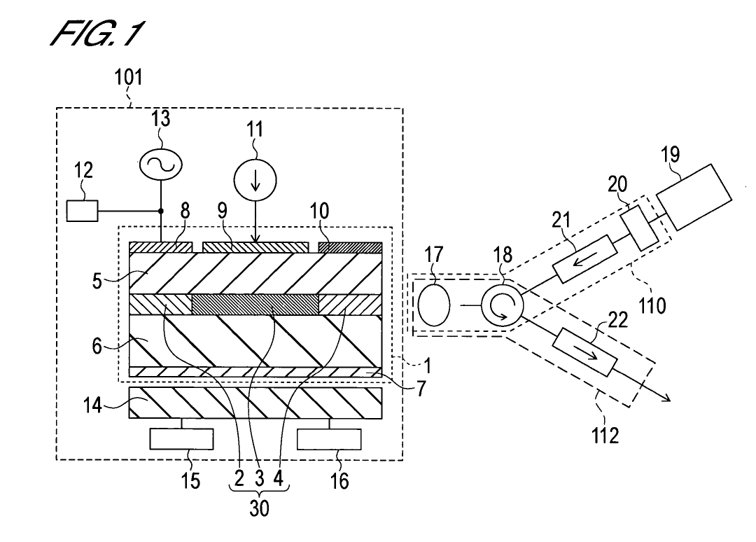

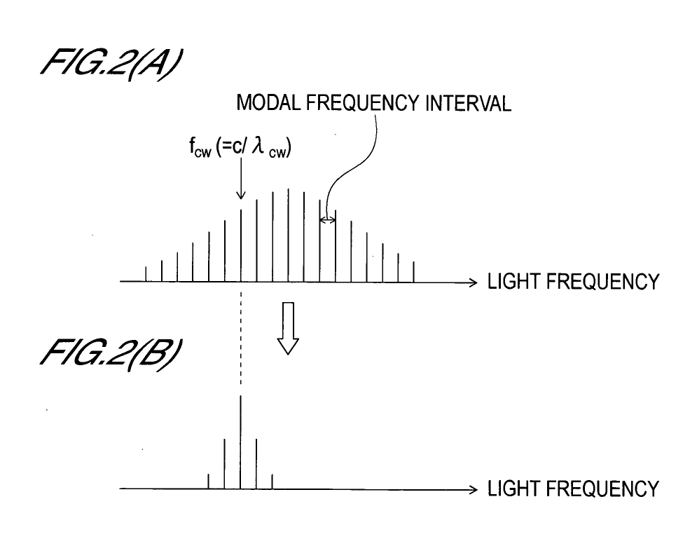

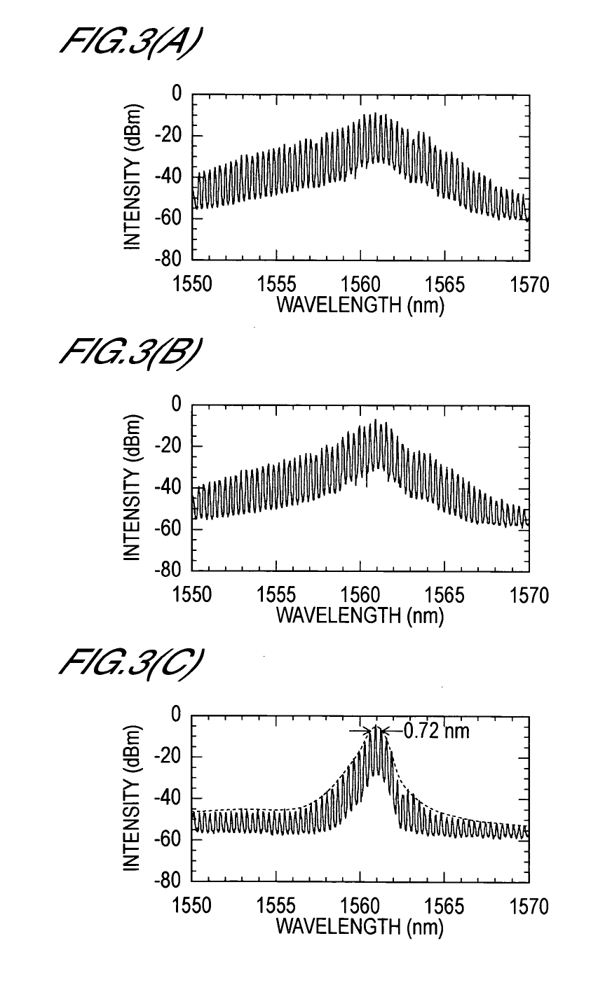

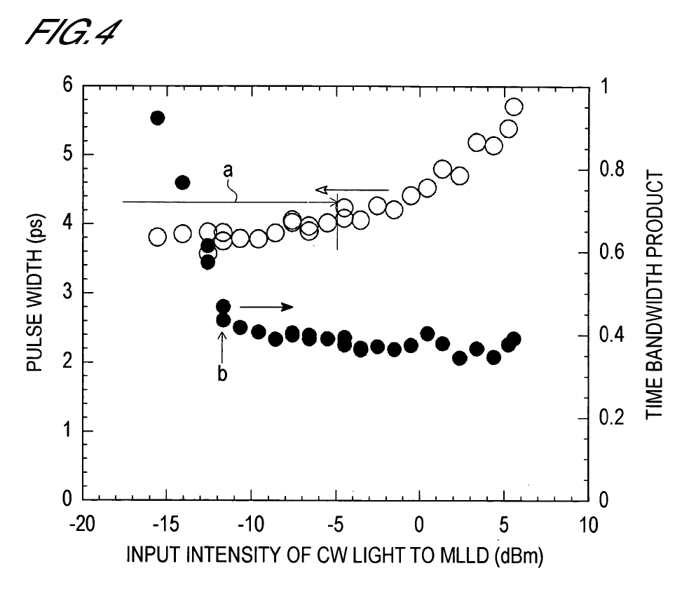

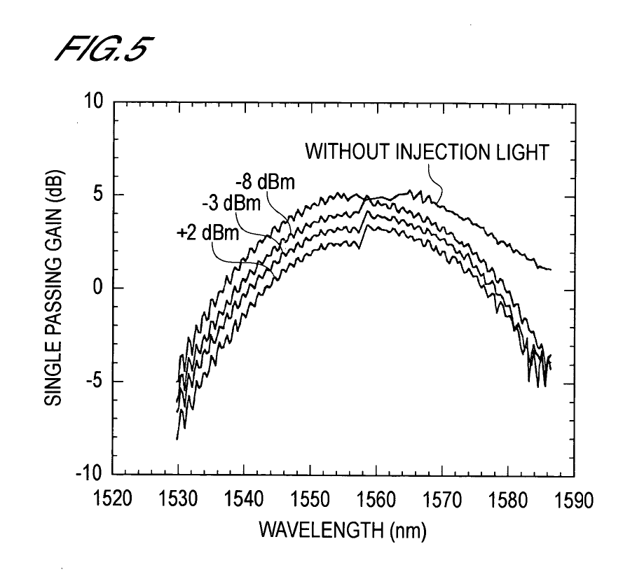

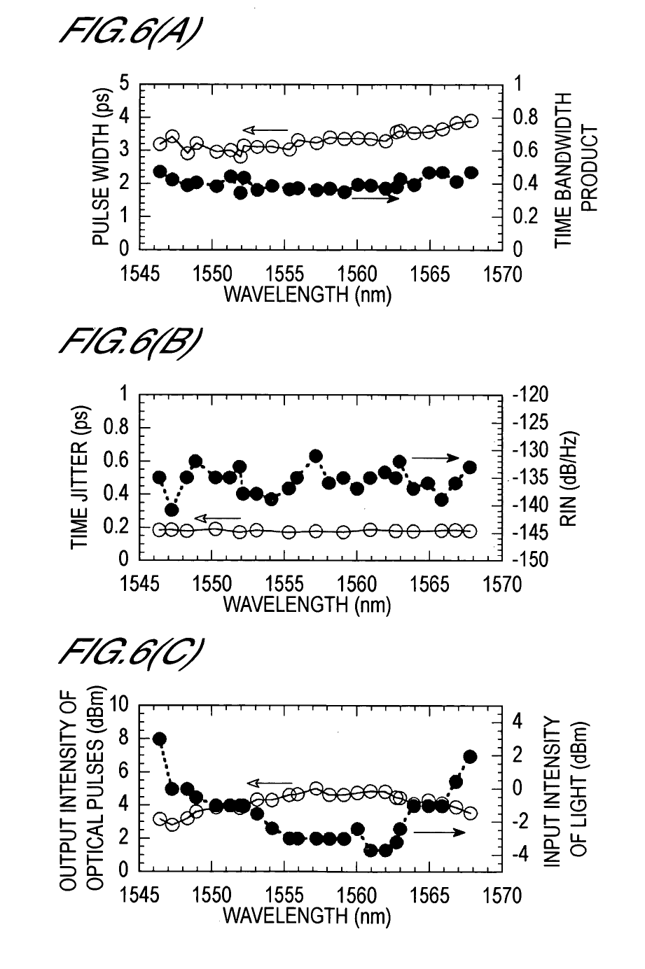

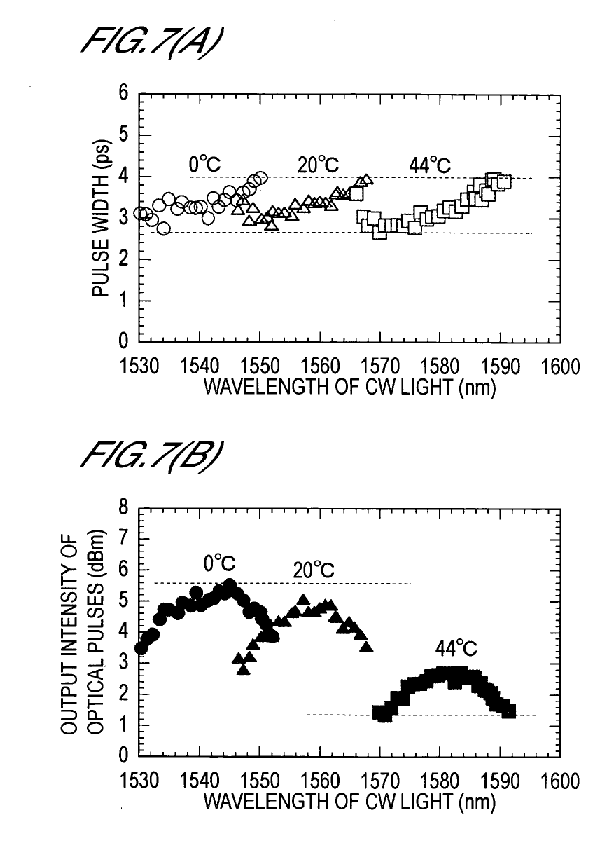

As described above, according to the first embodiment of the present invention, high quality optical pulses of which wavelength variable range is sufficiently wide, that is 20 nm, of which frequency chirping is small and noise is low, can be generated. Also the MLLD 1 used for the first embodiment is an FP type semiconductor laser diode, so the temperature change of the oscillation wavelength thereof can be effectively used. Now the experiment results, when a half width of the output optical pulses on the time axis and depending on the intensity thereof when the element temperature of the MLLD 1 is changed, will be described with reference to FIGS. 7(A) and (B).

In FIGS. 7(A) and (B), the abscissa is the wavelength of the CW light scaled in nm units. The ordinate in FIG. 7(A) is the full width at half maximum of the output optical pulses on the time axis scaled in ps units. The ordinate of FIG. 7(B) is the intensity of the output optical pulses scaled in dBm units. In FIG. 7(A), the case when the element temperature of the MLLD 1 is 0° C. is indicated by ∘, the case of 20° C. is indicated by Δ, and the case of 44° C. is indicated by □. In FIG. 7(B), the case when the element temperature of the MLLD 1 is 0° C. is indicated by ●, the case of 20° C. is indicated by ▴, and the case of 44° C. is indicated by ▪.

These quantities were measured under the same conditions as the above mentioned setup conditions. In other words, the sinusoidal voltage with a 39.81312 GHz frequency and a 25 dBm RF wave intensity are applied to the optical modulation area 2 by the modulation voltage source 13. The current injected into the optical gain area 3 by the first current source 11 is 83 mA. The DC bias voltage applied to the optical modulation area 2 by the voltage source 12 is −0.52 V.

The full width at half maximum of the output optical pulses on the time axis and dependency on the intensity thereof were measured while changing the element temperature of the MLLD 1 in a 0° C. to 44° C. range for a 62 nm width of a CW light wavelength between 1530 nm and 1592 nm. As FIG. 7(A) shows, output optical pulses of which the full width at half maximum is 2.7 ps to 4.0 ps on the time axis were acquired. The intensity of the output optical pulses was a 1.5 dBm minimum and a 5.5 dBm maximum. The fluctuation width of the intensity of the output optical pulses was maintained to be small, that was about 4.0 dB.

The CW light source 19 plays a role of generating CW light with a wavelength close to the wavelength of one longitudinal mode out of the oscillation longitudinal modes of the MLLD 1. Certainly the wavelength of the CW light to be output by the CW light source 19 must be close to the wavelength of one longitudinal mode in a range where the MLLD 1 can generate the optical injection locking phenomena.

In order to control the frequency of the optical pulses to be output using the MLLD device of the present invention, the following steps (A) to (F) can be executed.

(A) A step of oscillating MLLD:

The step of oscillating the MLLD 1 is implemented by supplying current in the forward direction in the optical gain area 3 of the MLLD 1, and performing carrier injection. This forward current is supplied by the first current source 11 via the p-side electrode 9 in the optical gain area 3.

(B) A step of implementing the mode-locking operation of the MLLD by performing optical modulation at a frequency obtained by multiplying a cyclic frequency of the resonator of the MLLD by a natural number in the optical modulation area:

Performing optical modulation at a frequency, obtained by multiplying a cyclic frequency of the resonator of the MLLD 1 by a natural number, in the optical modulation area 2 can be implemented by applying an AC voltage equivalent to the frequency, obtained by multiplying a cyclic frequency of the resonator of the MLLD 1 by a natural number, in the optical modulation area 2 using the modulation voltage source 13. The resonator of the MLLD 1 is an FP type optical resonator created by using both ends of the optical wave guide 30, including the optical modulation area 2, optical gain area 3 and passive wave-guiding area 4, as reflection mirrors. (C) A step of outputting a CW light with a frequency close to a frequency of one longitudinal mode out of the oscillation longitudinal modes of MLLD from the CW light source in a range where optical injection locking phenomena can be generated:

Outputting the CW light with a frequency close to the frequency of one longitudinal mode out of the oscillation longitudinal modes of the MLLD 1 from the CW light source 19 can be implemented by CW-operating a laser diode having a light with this frequency in its oscillation frequency band. The optical pulses equal to the frequency of this CW light are oscillated from the MLLD 1. In other words, the frequency of the optical pulses to be oscillated from the MLLD 1 can be controlled by changing the frequency of the CW light.

(D) A step of adjusting the polarization direction of the output light of the CW light source by the polarization plane adjustment element so that the polarization direction of the output light of the CW light source in the optical wave guide of the MLLD matches the polarization direction of the oscillation light of the MLLD, and inputting the output light to the input end of the optical wave guide of the MLLD:

Adjusting the polarization direction of the output light of the CW light source 19 so that the polarization direction of the output light of the CW light source 19 matches the polarization direction of the oscillation light of the MLLD 1 in the optical wave guide 30 in the MLLD 1 can be executed by using the polarization plane adjustment element 20, such as a wave plate. Inputting the output light of which the polarization direction was adjusted to the optical wave guide 30 of the MLLD 1 can be executed by the first optical coupling means 110.

(E) A step of adjusting the intensity of the CW light to be input to the optical wave guide of the MLLD from the CW light source so that the mode-locked optical pulses, of which the wavelength is the same as that of the output light of the CW light source, of which frequency chirping is suppressed, and of which phase noise is low, are output from the MLLD:

In the step of adjusting the intensity of the CW light to be input to the optical wave guide 30 of the MLLD 1 from the CW light source 19 so that the mode-locked optical pulses which frequency is equal to that of the output light of the CW light source 19 and of which frequency chirping is suppressed and phase noise is low are output from the MLLD 1, the drive current of the CW light source 19 is adjusted.

(F) A step of outputting the optical pulses from the MLLD 1:

The step of outputting the optical pulses from the MLLD 1 can be executed by the second optical coupling means 112.

As described above, according to the first embodiment, optical pulses of which the wavelength width in the wavelength variable area is sufficiently wide and of which frequency chirping is suppressed enough to be used for optical communication can be generated by adjusting the frequency of the CW light source and the element temperature of the MLLD by injecting the CW light to be output from the CW light source installed outside the FP type MLLD.

### Second Embodiment

(Configuration)

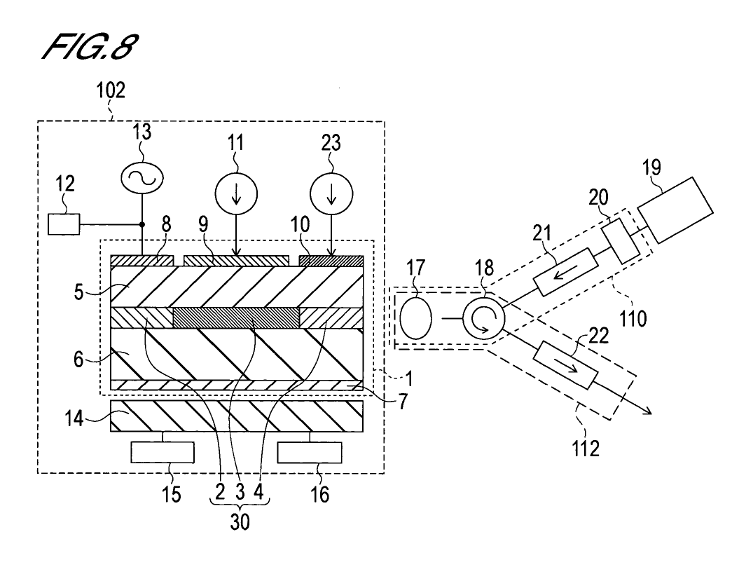

The configuration of the MLLD device according to the second embodiment of the present invention will now be described with reference to FIG. 8. The difference from the first embodiment is that the oscillation wavelength adjustment means is formed in the passive wave-guiding area 4. Specifically the oscillation wavelength adjustment means created in the passive wave-guiding area 4 is structured such that the current can be injected into the p-i-n junction created including the passive wave-guiding area 4 of the optical wave guide 30 by the second current source 23 via the p-side electrode 10 and the n-side common electrode 7. This p-i-n junction is created by the p-type clad layer 5, passive wave-guiding area 4 of the optical wave guide 30 which is the i-layer (intrinsic semiconductor layer) and n-type clad layer 6. In other words, the difference of this embodiment from the first embodiment is that the means for injecting current into the p-i-n junction is included. The rest of the configuration is the same as the MLLD device of the first embodiment, so redundant description is omitted for the identical parts.

(Operation)

In order to drive the MLLD device of the first embodiment controlling such that the frequency of the optical pulses to be output becomes a desired frequency, when the CW light is input to the optical wave guide 30 of MLLD 1, it is necessary to inject the CW light having a frequency close to the frequencies of one longitudinal mode out of the oscillation longitudinal modes by the mode-locking operation in a status where CW light is not injected into the MLLD 1. And by changing the frequency of the CW light to be injected into the MLLD 1 and causing optical injection locking, the frequency of the optical pulses to be output from the MLLD 1 has the following limitation. In other words, the frequency of the optical pulses to be output from the MLLD 1 is limited to a discrete frequency which lines up with an interval of a frequency corresponding to a mode-locked frequency, which is a cyclic frequency of the optical pulses to be generated.

In order to eliminate the above restriction and to freely select the frequency of the optical pulses to be output from the MLLD 1 continuously, it is necessary to introduce a structure to continuously change the longitudinal mode position (frequency in longitudinal mode) of the MLLD 1. This structure is oscillation wavelength adjustment means. There are a plurality of methods for creating this oscillation wavelength adjustment means.

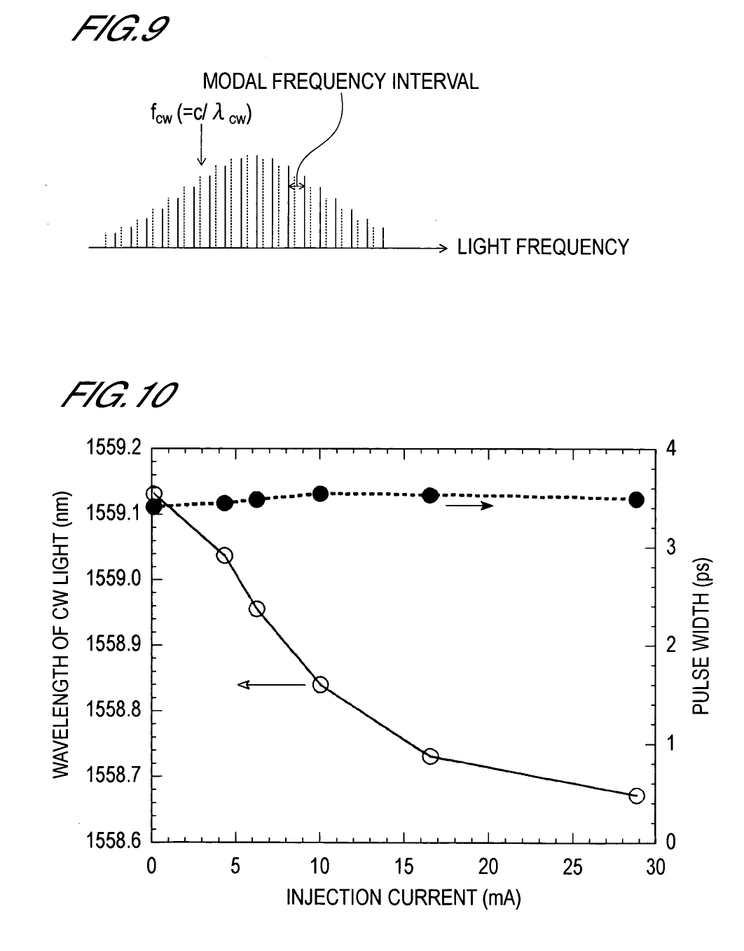

As the oscillation wavelength adjustment means for freely selecting a frequency of optical pulses to be output from the MLLD 1 continuously, a structure of changing the effective refractive index of the passive wave-guiding area 4 by plasma effect by injecting current into the passive wave-guiding area 4 is introduced in the optical pulse generation section 102 of the second embodiment. The change of the longitudinal mode position of the MLLD 1 by changing the effective refractive index of the passive wave-guiding area 4 will be described with reference to FIG. 9.

FIG. 9 is a diagram depicting the change of the longitudinal mode position of the MLLD 1 by the effective refractive index of the passive wave-guiding area 4, where the abscissa is the frequency of the lights generated in the optical wave guide 30 in the MLLD 1 in an arbitrary scale. The longitudinal mode is indicated by a line segment perpendicular to the abscissa, and the line segment indicated by a solid line is the longitudinal mode before the effective refractive index of the passive wave-guiding area 4 changes, and the line segment indicated by the dotted line is the longitudinal mode when the effective refractive index has changed. The interval of the respective line segment corresponds to the mode-locked frequency.

The position of the longitudinal mode can be continuously changed by continuously changing the current to be injected into the passive wave-guiding area 4 using the second current source 23. In other words, the position of the longitudinal mode can be changed according to the wavelength of an arbitrary CW light. Therefore in order to generate the optical pulses with a desired wavelength from the optical pulse generation section 102, one of the longitudinal modes is matched with a frequency corresponding to this wavelength, and the wavelength of the output CW light of the CW light source 19 is matched to this wavelength.

In the longitudinal modes of the MLLD 1 when current is not injected into the passive wave-guiding area 4 using the second current source 23 (indicated by the solid lines), longitudinal modes equal to the frequency fcw (=c/λcw) corresponding to the wavelength of the optical pulses to be output from the optical pulse generation section 102 do not exist. Therefore the longitudinal mode position is adjusted by injecting current into the passive wave-guiding area 4 from the second current source 23, so that a longitudinal mode equal to the frequency fcw exists by adjusting the effective refractive index of the passive wave-guiding area 4. In this way, if CW light with a λm wavelength is injected into the optical wave guide 30 of the MLLD 1, optical injection locking occurs and optical pulses with a λcw wavelength are output from the optical pulse generation section 102.

In order to control the wavelength of the optical pulses to be acquired using the optical pulse generation section 102, a step of adjusting the position of the longitudinal mode by injecting current into the p-i-n junction, which is created including the passive wave-guiding area 4, is added to steps (A) to (F) described in the first embodiment. According to the wavelength control method of the output optical pulses of the MLLD device including this step, optical pulses with a desired λcw wavelength can be output from the optical pulse generation section 102.

In other words, the wavelength control method for the output optical pulses of the MLLD device of the second embodiment is executed including the following steps.

(A) A step of oscillating the MLLD:

(B1) a step of implementing the mode-locking operation of the MLLD by performing optical modulation at a frequency obtained by multiplying a cyclic frequency of a resonator of the MLLD by a natural number in the optical modulation area:

(C) a step of outputting a CW light with a wavelength close to the wavelength of one longitudinal mode out of the oscillation longitudinal modes of the MLLD from the CW light source in a range where the optical injection locking phenomena can be generated:

(B2) a step of adjusting the position of the longitudinal mode of the MLLD by the oscillation wavelength adjustment means so that the wavelength of the CW light matches the wavelength of one longitudinal mode out of the longitudinal modes of the MLLD in mode-locking operation,

(D) a step of adjusting the polarization direction of the output light of the CW light source by a polarization plane adjustment element so that the polarization direction of the output light of the CW light source in the optical wave guide 30 in the MLLD matches the polarization direction of the oscillation light of the MLLD, and inputting this output light into the optical wave guide 30 of the MLLD:

(E) a step of adjusting the intensity of the CW light to be input to the optical wave guide 30 of the MLLD from the CW light source so that the mode-locked optical pulses, of which the wavelength is the same as that of the output light of the CW light source, of which the frequency chirping is suppressed, and of which phase noise is low, are output from the MLLD:

(F) a step of outputting the optical pulses from-the MLLD.

Here step (B2) is constructed as

(b2) a step of adjusting the position of the longitudinal mode of the MLLD by injecting current into the p-i-n junction created including the passive wave-guiding area so that the wavelength of the CW light matches the wavelength of one longitudinal mode out of the longitudinal modes of the MLLD in mode-locking operation.

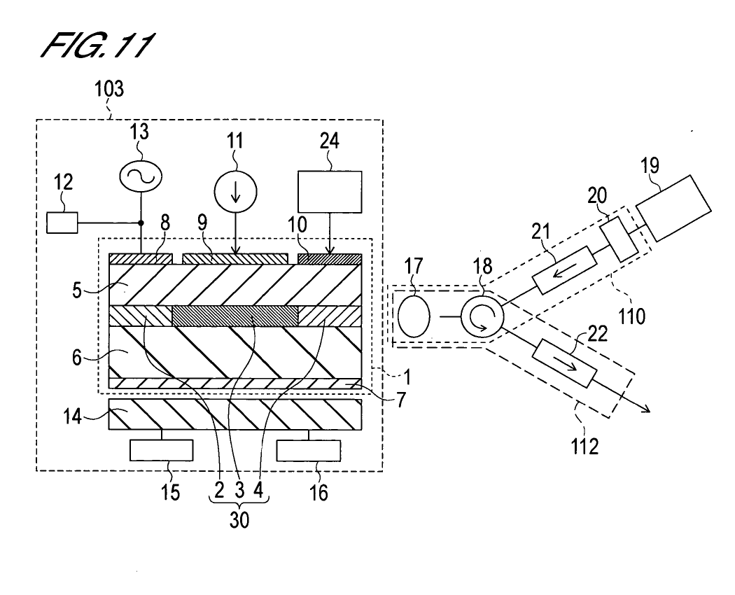

If the maximum value of the change of the longitudinal mode position by plasma effect is greater than the longitudinal mode interval of the MLLD 1, then continuous wavelength change can be implemented perfectly. The result of experiment, when the wavelength of the CW light is continuously changed while changing the injection current to the passive wave-guiding area 4, and the wavelength of the optical pulses to be output from the optical pulse generation section 102 was controlled, will be described with reference to FIG. 10.

The abscissa in FIG. 10 indicates the value of the current injected into the passive wave-guiding area 4 scaled in mA units. The ordinate at the left side indicates the wavelength of the CW light which was input to the optical wave guide 30 of the MLLD 1 scaled in nm units, and the ordinate at the right side indicates the full width at half maximum of the intensity waveform of the optical pulses which are output from the optical pulse generation section 102 on the time axis scaled in ps units. The wavelength of the CW light which was input to the optical wave guide 30 of the MLLD 1 is indicated by ∘, and the full width at half maximum of the intensity waveform of the optical pulses to be output from the optical pulse generation section 102 on the time axis is indicated by ●.

The experiment was performed while adjusting the injection current into the passive wave-guiding area 4 so that the wavelength of the CW light to be input into the optical wave guide 30 of the MLLD 1 becomes the same as the wavelength corresponding to the frequency of one longitudinal mode out of the longitudinal modes of the MLLD 1. In this experiment, six types of wavelengths of the CW light to be input into the optical wave guide 30 of the MLLD 1 were freely selected and the injection current to the passive wave-guiding area 4 was adjusted so that a longitudinal mode equal to the frequency corresponding to the wavelength of the respective CW light exists.

In this experiment the position of the longitudinal mode of the MLLD 1 was changed 0.4 nm by changing the injection current to the passive wave-guiding area 4 from 0 mA to 29 mA. This value is greater than the value of the interval of the longitudinal mode (0.33 nm) of the MLLD 1, and it was confirmed that the wavelength of the optical pulses to be output from the optical pulse generation section 102 can be continuously changed by the wavelength control method for the output optical pulses of the MLLD device of the second embodiment.

### Third Embodiment

(Configuration)

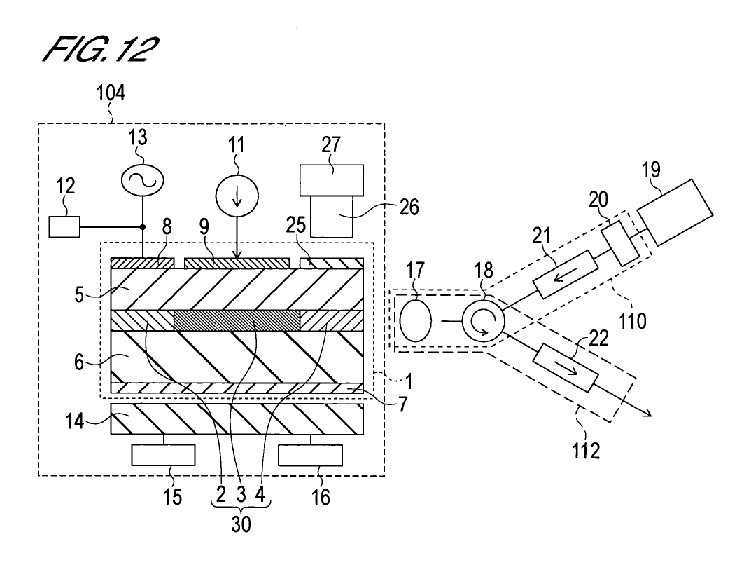

The configuration of the MLLD device according to the third embodiment of the present invention will now be described with reference to FIG. 11. The difference from the second embodiment is that the oscillation wavelength adjustment means is constructed such that the reverse bias voltage can be applied to the p-i-n junction comprised of the p-type clad layer 5, passive wave-guiding area 4 of the optical wave guide 30, which is the i-layer (intrinsic semiconductor layer) and n-type clad layer 6 by the reverse bias voltage source 24 via the p-side electrode 10 and the n-side common electrode 7. In other words, the difference of this embodiment from the first embodiment is that the means for applying the reverse bias voltage to the p-i-n junction is included. The rest of the configuration is the same as the MLLD device in the first embodiment, so redundant description is omitted for identical parts.

(Operation)

The MLLD device of the third embodiment also comprises oscillation wavelength adjustment means for controlling the wavelength of the optical pulses to be output continuously, just like the MLLD device of the second embodiment. This configuration of the oscillation wavelength adjustment means is different from that of the MLLD device of the second embodiment on the following points. This oscillation wavelength adjustment means changes the effective refractive index of the passive wave-guiding area 4 by the Pockels effect, which is generated in the passive wave-guiding area 4 by applying the reverse bias voltage to the p-i-n junction created including the passive wave-guiding area 4.

In the MLLD device of the second embodiment, current is injected into the passive wave-guiding area 4 and by the plasma effect result from this, the effective refractive index of the passive wave-guiding area 4 is changed. However injecting current into the passive wave-guiding area 4 increases free carrier absorption, and light loss in the passive wave-guiding area 4 of the optical wave guide 30 of the MLLD 1 increases. Therefore the intensity of the optical pulses to be output from the optical pulse generation section 102 of the MLLD device of the second embodiment decreases, which is a problem.

In the MLLD device of the third embodiment, the Pockels effect, which is generated in the passive wave-guiding area 4 by applying the reverse bias voltage to the p-i-n junction created including the passive wave-guiding area 4, is used, so current does not flow into the passive wave-guiding area 4. Therefore free carrier absorption is not generated in the passive wave-guiding area 4. This means that the intensity of the optical pulses to be output from the optical pulse generation section 103 of the MLLD device of the third embodiment does not decrease, which is an advantage.

In order to control the wavelength of the optical pulses acquired by using the optical pulse generation section 103, a step of applying the reverse bias voltage to the p-i-n junction created including the passive wave-guiding area 4 and adjusting the position of the longitudinal mode is added to steps (A) to (F) described in the first embodiment. According to the wavelength control method for the output optical pulses of the MLLD device including this step, optical pulses with a desired λcw wavelength can be output from the optical pulse generation section 103.

In other words, the wavelength control method for the output optical pulses of the MLLD device of the third embodiment is executed including the following steps.

(A) A step of oscillating the MLLD:

(B1) a step of implementing the mode-locking operation of the MLLD by performing optical modulation at a frequency obtained by multiplying a cyclic frequency of a resonator of the MLLD by a natural number in the optical modulation area:

(C) a step of outputting a CW light close to the wavelength of one longitudinal mode out of the oscillation longitudinal modes of the MLLD from the CW light source in a range where the optical injection locking phenomena can be generated:

(B2) a step of adjusting the position of the longitudinal mode of the MLLD by the oscillation wavelength adjustment means so that the wavelength of the CW light matches the wavelength of one longitudinal mode out of the longitudinal modes of the MLLD in mode-locking operation:

(D) a step of adjusting the polarization direction of the output light of the CW light source by a polarization plane adjustment element so that the polarization direction of the output light of the CW light source in the optical wave guide 30 in the MLLD matches the polarization direction of the oscillation light of the MLLD, and inputting this output light to the optical wave guide 30 of the MLLD:

(E) a step of adjusting the intensity of the CW light to be input to the optical wave guide 30 of the MLLD from the CW light source so that the mode-locked optical pulses, of which the wavelength is the same as that of the output light of the CW light source, of which frequency chirping is suppressed, and of which phase noise is low, are output from the MLLD:

(F) a step of outputting the optical pulses from the MLLD.

Here the step (B2) is constructed as (b3) a step of adjusting the position of the longitudinal mode of the MLLD by applying the reverse bias voltage to the p-i-n junction created including the passive wave-guiding area so that the wavelength of the CW light matches the wavelength of one longitudinal mode out of the longitudinal modes of the MLLD in mode-locking operation.

If the maximum value of the change of the longitudinal mode position by the Pockels effect is greater than the longitudinal mode interval of the MLLD 1, continuous wavelength change can be implemented perfectly.

### Fourth Embodiment

(Configuration)

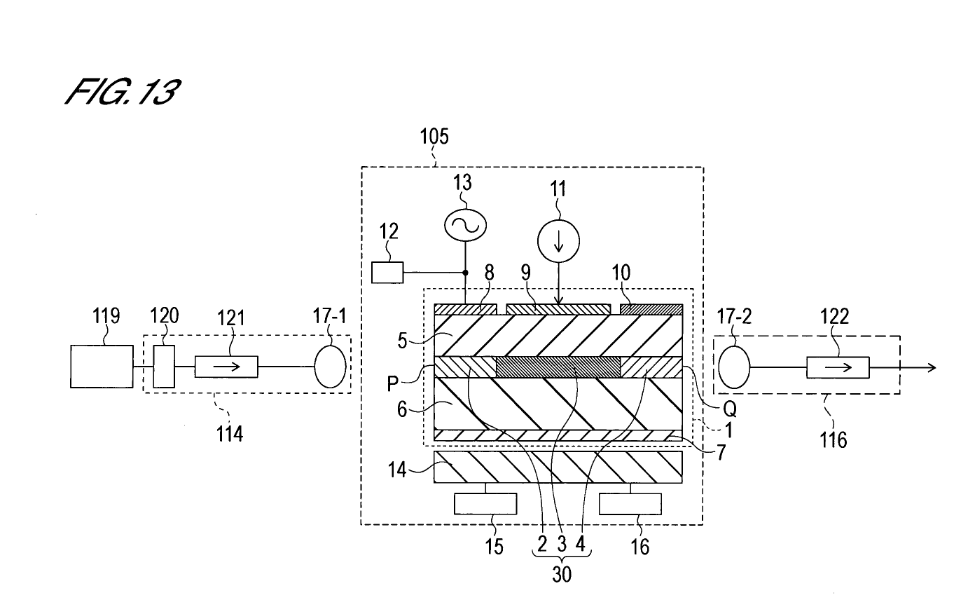

The configuration of the MLLD device according to the fourth embodiment of the present invention will now be described with reference to FIG. 12. The difference from the first embodiment is that the passive wave-guiding area temperature control means, for controlling the temperature of the passive wave-guiding area 4, is added as the oscillation wavelength adjustment means. To control the temperature of the passive wave-guiding area 4, the insulation layer 25 is formed directly on the passive wave-guiding area 4, sandwiching the p-type clad layer 5, and a resistance film 26, such as platinum thin film, is formed directly on this insulation layer 25. This resistance film 26 is heated by supplying current by the third current source 27.

In other words, the passive wave-guiding area temperature control means is comprised of the insulation layer 25 formed by sandwiching the p-type clad layer 5, a resistance film 26, such as platinum thin film, formed directly on the insulation layer 25, and the third current source 27 for supplying current to the resistance film 26.

The configuration, other than the passive wave-guiding area temperature control means, is the same as that of the MLLD device of the first embodiment, so redundant description is omitted for these identical parts.

(Operation)

The MLLD device of the fourth embodiment also comprises an oscillation wavelength adjustment means for controlling the wavelength of the optical pulses to be output continuously, just like the MLLD devices of the second embodiment and third embodiment. The difference from the MLLD devices of the second embodiment and third embodiment is that the passive wave-guiding area temperature control means, for changing the effective refractive index of the passive wave-guiding area 4, is disposed as the oscillation wavelength adjustment means.

As the oscillation wavelength adjustment means, this passive wave-guiding area temperature control means is constructed as follows. The passive wave-guiding area temperature control means is constructed such that current can be supplied from the third current source 27 to the resistance film 26, such as a platinum thin film, formed directly on the insulation layer 25, which is formed sandwiching the p-type clad layer 5. By supplying the current to the resistance film 26, the temperature of the passive wave-guiding area 4 is increased, and the effective refractive index of the passive wave-guiding area 4 is changed.

In the MLLD device of the second embodiment, the effective refractive index of the passive wave-guiding area 4 is changed by the plasma effect. In the MLLD device of the third embodiment, the effective refractive index of the passive wave-guiding area 4 is changed by generating the Pockels effect.

If the effective refractive index of the passive wave-guiding area 4 is changed by increasing the temperature of the passive wave-guiding area 4, the effective refractive index can be greatly changed than changing the effective refractive index of the passive wave-guiding area 4 by the plasma effect. Also free carrier absorption does not occur. In other words, if the mode-locked frequency is high and the longitudinal mode interval is several nm or more, the position of the longitudinal mode must be changed for several nm or more for adjustment. In such a case, it is advantageous to use the MLLD device of the fourth embodiment.

In order to control the wavelength of the optical pulses acquired by using the optical pulse generation section 104, a step of controlling the temperature of the passive wave-guiding area 4 using the passive wave-guiding area temperature control means and adjusting the position of the longitudinal mode is added to steps (A) to (F) described in the first embodiment. According to the wavelength control method for output optical pulses of the MLLD device including this step, optical pulses with a desired λcw wavelength can be output from the optical pulse generation section 104.

In other words, the wavelength control method for the output optical pulses of the MLLD device of the fourth embodiment is executed including the following steps.

(A) A step of oscillating the MLLD:

(B1) a step of implementing the mode-locking operation of the MLLD by performing optical modulation at a frequency obtained by multiplying a cyclic frequency of a resonator of the MLLD by a natural number in the optical modulation area:

(C) a step of outputting a CW light close to the wavelength of one longitudinal mode out of the oscillation longitudinal modes of the MLLD from the CW light source in a range where the optical injection locking phenomena can be generated:

(B2) a step of adjusting the position of the longitudinal mode of the MLLD by the oscillation wavelength adjustment means so that the wavelength of the CW light matches the wavelength of one longitudinal mode out of the longitudinal modes of the MLLD in mode-locking operation:

(D) a step of adjusting the polarization direction of the output light of the CW light source by a polarization plane adjustment element so that the polarization direction of the output light of the CW light source in the optical wave guide 30 in the MLLD matches the polarization direction of the oscillation light of the MLLD, and inputting this output light to the optical wave guide 30 of the MLLD:

(E) a step of adjusting the intensity of the CW light to be input to the optical wave guide 30 of the MLLD from the CW light source so that the mode-locked optical pulses, of which the wavelength is the same as that of the output light of the CW light source, of which frequency chirping is suppressed, and of which phase noise is low, are output from the MLLD:

(F) a step of outputting the optical pulses from the MLLD.

Here the step (B2) is constructed as (b4) a step of adjusting the position of the longitudinal mode by controlling the temperature of the passive wave-guiding area 4 using the passive wave-guiding area temperature control means so that the wavelength of the CW light matches the wavelength of one longitudinal mode out of the longitudinal modes of the MLLD in mode-locking operation.

If the maximum value of the change of the longitudinal mode position by controlling the temperature of the passive wave-guiding area 4 is greater than the longitudinal mode interval of the MLLD 1, continuous wavelength change can be implemented perfectly.

### Fifth Embodiment

The MLLD device of the fifth embodiment is characterized in the positional relationship of the first optical coupling means 114, second optical coupling means 116 and optical pulse generation section 105. The configuration of the MLLD device of the fifth embodiment will now be described with reference to FIG. 13. The first optical coupling means 114 is comprised of a polarization plane adjustment element 120, first optical isolator 121 and coupling lens 17-1. The second optical coupling means 116 is comprised of a coupling lens 17-2 and second optical isolator 122.

The CW light to be output from the CW light source 119 is input from the input end P at one side of the optical wave guide 30 of the MLLD 1 to the optical wave guide 30 of the MLLD 1 via the first optical coupling means 114, and the optical pulses to be output from the optical wave guide 30 of the MLLD 1 are output from the output end Q at the other side of the optical wave guide 30 of the MLLD 1 to the outside via the second optical coupling means 116.

For the optical pulse generation section 105, any one of the optical pulse generation sections 101 to 104, constituting the MLLD device of the first to fourth embodiments, can be used. Depending on which one of the optical pulse generation sections 101 to 104 is used, advantages similar to the MLLD device of the first embodiment to fourth embodiment can be implemented.

The major components of the MLLD device of the fifth embodiment are as follows. This MLLD device of the present invention is comprised of an MLLD 1, CW light source 119, first optical coupling means 114 and second optical coupling means 116.

The MLLD 1 further comprises an optical wave guide 30 where an optical gain area 3 in which population inversion is created, and an optical modulation area 2 having a function to modulate light intensity, are included, and the optical gain area 3 and optical modulation area 2 are laid out in series.

The CW light source 119 generates the CW light with a wavelength close to the wavelength of one longitudinal mode out of the oscillation longitudinal modes of the MLLD 1. The first optical coupling means 114 comprises a polarization plane adjustment element 120 for inputting the output light of the CW light source 119 to the optical wave guide 30 of the MLLD 1, and controlling the polarization direction of the output light of the CW light source 119 so that the polarization direction of the output light of the CW light source 119 in the optical wave guide 30 of the MLLD 1 matches the polarization direction of the oscillation light of the MLLD 1. The second optical coupling means 116 is installed for outputting the output optical pulses of the MLLD 1 to the outside. The CW light, which is output from the CW light source 119, is input to the optical wave guide 30 of the MLLD 1 from the input end P at one side of the optical wave guide 30 of the MLLD 1 via the first optical coupling means 114, and the optical pulses to be output from the optical wave guide 30 of the MLLD 1 are output from the output end Q at the other side of the optical wave guide 30 of the MLLD 1 to the outside via the second optical coupling means 116.

Unlike the MLLD devices of the first embodiment to fourth embodiment, the MLLD device of the fifth embodiment does not need an optical circulator. So the MLLD device of the fifth embodiment implements low cost. The optical pulse generation section 105, the first optical isolator 121 and the second optical isolator 122 can be easily integrated into a module, so the MLLD device of the fifth embodiment can implement a wavelength variable MLLD module, integrating composing elements other than the CW light source 119. As a result, further compactness and stability of an MLLD device can be implemented compared with the first embodiment to fourth embodiment.

The effect of optical injection locking implemented by the MLLD device of the present invention was confirmed by experiment in the first embodiment to fifth embodiment, but this effect can be acquired not only from the MLLD 1, which performs the active mode-locking operation used for these embodiments, but also for the passive mode locked laser and hybrid mode locked laser, which uses both the active mode locked laser and passive mode locked laser. If the wavelength variable mode locked laser device is constructed using the passive mode locked laser, then a modulation voltage supply is unnecessary, so the optical injection locking of the present invention can be implemented for a mode locked laser which operates at a high cyclic period exceeding the operable speed of electronic devices constituting a mode locked laser device.

As a physical law to cause the change of the effective refractive index of the passive wave-guiding area used as the oscillation wavelength adjustment means in the second embodiment and third embodiment, not only the plasma effect and Pockels effect, but also the band filling effect and Franz-Keldish effect can be used.

What is claimed is:

1. A mode-locked laser diode device comprising:
a mode-locked laser diode comprising an optical wave guide where an optical gain area in which population inversion is created and an optical modulation area having a function to modulate light intensity are included and said optical gain area and said optical modulation area are laid out in series;
a continuous wave light output light source for generating continuous wave lights with wavelengths close to the wavelength of one longitudinal mode out of the oscillation longitudinal modes of said mode-locked laser diode in a range where the optical injection locking phenomena can be generated;
first optical coupling means for inputting the output light of said continuous wave light output light source to said optical wave guide of said mode-locked laser diode, comprising a polarization plane adjustment element for controlling the polarization direction of the output light of said continuous wave light output light source so that the polarization direction of the output light of said continuous wave light output light source in said optical wave guide of said mode-locked laser diode matches the polarization direction of the oscillation light of said mode-locked laser diode; and
second optical coupling means for outputting optical pulses, which are output by said mode-locked laser diode, to the outside.

2. The mode-locked laser diode device according to claim 1, wherein said optical wave guide includes a passive wave-guiding area in addition to said optical gain area and said optical modulation area, and said optical gain area, said optical modulation area and said passive wave-guiding area are laid out in series, and oscillation wavelength adjustment means is formed in said passive wave-guiding area.

3. The mode-locked laser diode device according to claim 1, wherein the continuous wave light to be output from said continuous wave light output light source is input to the optical wave guide of said mode-locked laser diode from the input end at one side of the optical wave guide of said mode-locked laser diode via said first optical coupling means, and the optical pulses to be output from the optical wave guide of said mode-locked laser diode is output to the outside from the output end at the other side of the optical wave guide of said mode-locked laser diode via said second optical coupling means.

4. The mode-locked laser diode device according to claim 2, wherein the continuous wave light to be output from said continuous wave light output light source is input to the optical wave guide of said mode-locked laser diode from the input end at one side of the optical wave guide of said mode-locked laser diode via said first optical coupling means, and the optical pulses to be output from the optical wave guide of said mode-locked laser diode is output to the outside from the output end at the other side of the optical wave guide of said mode-locked laser diode via said second optical coupling means.

5. A method for controlling the wavelength of optical pulses to be output by the mode-locked laser diode device according to claim 1, comprising the steps of:
(A) oscillating said mode-locked laser diode;
(B) implementing mode-locking operation of said mode-locked laser diode by performing optical modulation at a frequency obtained by multiplying a cyclic frequency of a resonator of said mode-locked laser diode by a natural number in said optical modulation area;
(C) outputting continuous wave lights with wavelength close to the wavelength of one longitudinal mode out of the oscillation longitudinal modes of said mode-locked laser diode from said continuous wave light output light source in a range where optical injection locking phenomena can be generated;
(D) adjusting the polarization direction of the output light of said continuous wave light output light source by said polarization plane adjustment element so that the polarization direction of the output light of said continuous wave light output light source in said optical wave guide of said mode-locked laser diode matches the polarization direction of the oscillation light of said mode-locked laser diode, and inputting said output light to said optical wave guide of said mode-locked laser diode;
(E) adjusting the intensity of the continuous wave lights to be input to said optical wave guide of said mode-locked laser diode from said continuous wave light output light source so that the mode-locked optical pulses, of which the wavelength is the same as that of the output lights of said continuous wave light output light source, of which frequency chirping is suppressed, and of which phase noise is low, are output from said mode-locked laser diode; and
(F) outputting the optical pulses from said mode-locked laser diode.

6. A method for controlling the wavelength of optical pulses to be output by the mode-locked laser diode device according to claim 3, comprising the steps of:
(A) oscillating said mode-locked laser diode;
(B) implementing mode-locking operation of said mode-locked laser diode by performing optical modulation at a frequency obtained by multiplying a cyclic frequency of a resonator of said mode-locked laser diode by a natural number in said optical modulation area;
(C) outputting continuous wave lights with wavelength close to the wavelength of one longitudinal mode out of the oscillation longitudinal modes of said mode-locked laser diode from said continuous wave light output light source in a range where optical injection locking phenomena can be generated;
(D) adjusting the polarization direction of the output light of said continuous wave light output light source by said polarization plane adjustment element so that the polarization direction of the output light of said continuous wave light output light source in said optical wave guide of said mode-locked laser diode matches the polarization direction of the oscillation light of said mode-locked laser diode, and inputting said output light to said optical wave guide of said mode-locked laser diode;
(E) adjusting the intensity of the continuous wave lights to be input to said optical wave guide of said mode-locked laser diode from said continuous wave light output light source so that the mode-locked optical pulses, of which the wavelength is the same as that of the output lights of said continuous wave light output light source, of which frequency chirping is suppressed, and of which phase noise is low, are output from said mode-locked laser diode; and
(F) outputting the optical pulses from said mode-locked laser diode.

7. A method for controlling the wavelength of optical pulses to be output by the mode-locked laser diode device according to claim 2, comprising the steps of:
(A) oscillating said mode-locked laser diode;
(B1) implementing mode-locking operation of said mode-locked laser diode by performing optical modulation at a frequency obtained by multiplying a cyclic frequency of a resonator of said mode-locked laser diode by a natural number in said optical modulation area;
(C) outputting continuous wave lights with wavelength close to the wavelength of one longitudinal mode out of the oscillation longitudinal modes of said mode-locked laser diode from said continuous wave light output light source in a range where optical injection locking phenomena can be generated;
(B2) adjusting the position of the longitudinal mode of said mode-locked laser diode by said oscillation wavelength adjustment means so that the wavelength of said continuous wave lights matches the wavelength of one longitudinal mode out of the longitudinal modes of said mode-locked laser diode which is in mode-locked operation;
(D) adjusting the polarization direction of the output light of said continuous wave light output light source by said polarization plane adjustment element so that the polarization direction of the output light of said continuous wave light output light source in said optical wave guide of said mode-locked laser diode matches the polarization direction of the oscillation light of said mode-locked laser diode, and inputting said output light to said optical wave guide of said mode-locked laser diode;
(E) adjusting the intensity of the continuous wave lights to be input to said optical wave guide of said mode-locked laser diode from said continuous wave light output light source so that the mode-locked optical pulses, of which the wavelength is the same as that of the output lights of said continuous wave light output light source, of which frequency chirping is suppressed, and of which phase noise is low, are output from said mode-locked laser diode; and
(F) outputting the optical pulses from said mode-locked laser diode.

8. A method for controlling the wavelength of optical pulses to be output by the mode-locked laser diode device according to claim 4, comprising the steps of:
(A) oscillating said mode-locked laser diode;
(B1) implementing mode-locking operation of said mode-locked laser diode by performing optical modulation at a frequency obtained by multiplying a cyclic frequency of a resonator of said mode-locked laser diode by a natural number in said optical modulation area;
(C) outputting continuous wave lights with wavelength close to the wavelength of one longitudinal mode out of the oscillation longitudinal modes of said mode-locked laser diode from said continuous wave light output light source in a range where optical injection locking phenomena can be generated;
(B2) adjusting the position of the longitudinal mode of said mode-locked laser diode by said oscillation wavelength adjustment means so that the wavelength of said continuous wave lights matches the wavelength of one longitudinal mode out of the longitudinal modes of said mode-locked laser diode which is in mode-locked operation;
(D) adjusting the polarization direction of the output light of said continuous wave light output light source by said polarization plane adjustment element so that the polarization direction of the output light of said continuous wave light output light source in said optical wave guide of said mode-locked laser diode matches the polarization direction of the oscillation light of said mode-locked laser diode, and inputting said output light to said optical wave guide of said mode-locked laser diode;
(E) adjusting the intensity of the continuous wave lights to be input to said optical wave guide of said mode-locked laser diode from said continuous wave light output light source so that the mode-locked optical pulses, of which the wavelength is the same as that of the output lights of said continuous wave light output light source, of which frequency chirping is suppressed, and of which phase noise is low, are output from said mode-locked laser diode; and
(F) outputting the optical pulses from said mode-locked laser diode.

9. The mode-locked laser diode device according to claim 2, wherein said oscillation wavelength adjustment means is means for injecting current into the p-i-n junction which is created including said passive wave-guiding area.

10. The mode-locked laser diode device according to claim 4, wherein said oscillation wavelength adjustment means is means for injecting current into the p-i-n junction which is created including said passive wave-guiding area.

11. A method for controlling the wavelength of optical pulses to be output by the mode-locked laser diode according to claim 9, comprising the steps of:
(A) oscillating said mode-locked laser diode;
(b1) implementing mode-locking operation of said mode-locked laser diode by performing optical modulation at a frequency obtained by multiplying a cyclic frequency of a resonator of said mode-locked laser diode by a natural number in said optical modulation area;
(C) outputting continuous wave lights with wavelength close to the wavelength of one longitudinal mode out of the oscillation longitudinal modes of said mode-locked laser diode from said continuous wave light output light source in a range where optical injection locking phenomena can be generated;
(b2) adjusting the position of the longitudinal mode of said mode-locked laser diode by injecting current into the p-i-n junction created including said passive wave-guiding area so that the wavelength of said continuous wave lights matches the wavelength of one longitudinal mode out of the longitudinal modes of said mode-locked laser diode which is in mode-locked operation;
(D) adjusting the polarization direction of the output light of said continuous wave light output light source by said polarization plane adjustment element so that-the polarization direction of the output light of said continuous wave light output light source in said optical wave guide of said mode-locked laser diode matches the polarization direction of the oscillation light of said mode-locked laser diode, and inputting said output light to said optical wave guide of said mode-locked laser diode;
(E) adjusting the intensity of the continuous wave lights to be input to said optical wave guide of said mode-locked laser diode from said continuous wave light output light source so that the mode-locked optical pulses, of which the wavelength is the same as that of the output lights of said continuous wave light output light source, of which frequency chirping is suppressed, and of which phase noise is low, are output from said mode-locked laser diode; and
(F) outputting the optical pulses from said mode-locked laser diode.

12. A method for controlling the wavelength of optical pulses to be output by the mode-locked laser diode according to claim 10, comprising the steps of:
(A) oscillating said mode-locked laser diode;
(b1) implementing mode-locking operation of said mode-locked laser diode by performing optical modulation at a frequency obtained by multiplying a cyclic frequency of a resonator of said mode-locked laser diode by a natural number in said optical modulation area;
(C) outputting continuous wave lights with wavelength close to the wavelength of one longitudinal mode out of the oscillation longitudinal modes of said mode-locked laser diode from said continuous wave light output light source in a range where optical injection locking phenomena can be generated;
(b2) adjusting the position of the longitudinal mode of said mode-locked laser diode by injecting current into the p-i-n junction created including said passive wave-guiding area so that the wavelength of said continuous wave lights matches the wavelength of one longitudinal mode out of the longitudinal modes of said mode-locked laser diode which is in mode-locked operation;
(D) adjusting the polarization direction of the output light of said continuous wave light output light source by said polarization plane adjustment element so that the polarization direction of the output light of said continuous wave light output light source in said optical wave guide of said mode-locked laser diode matches the polarization direction of the oscillation light of said mode-locked laser diode, and inputting said output light to said optical wave guide of said mode-locked laser diode;
(E) adjusting the intensity of the continuous wave lights to be input to said optical wave guide of said mode-locked laser diode from said continuous wave light output light source so that the mode-locked optical pulses, of which the wavelength is the same as that of the output lights of said continuous wave light output light source, of which frequency chirping is suppressed, and of which phase noise is low, are output from said mode-locked laser diode; and
(F) outputting the optical pulses from said mode-locked laser diode.

13. The mode-locked laser diode device according to claim 2, wherein said oscillation wavelength adjustment means is means for applying reverse bias voltage to the p-i-n junction which is created including said passive wave-guiding area.

14. The mode-locked laser diode device according to claim 4, wherein said oscillation wavelength adjustment means is means for applying reverse bias voltage to the p-i-n junction which is created including said passive wave-guiding area.

15. A method for controlling the wavelength of optical pulses to be output by the mode-locked laser diode according to claim 13, comprising the steps of:
(A) oscillating said mode-locked laser diode;
(b1) implementing mode-locking operation of said mode-locked laser diode by performing optical modulation at a frequency obtained by multiplying a cyclic frequency of a resonator of said mode-locked laser diode by a natural number in said optical modulation area;
(C) outputting continuous wave lights with wavelength close to the wavelength of one longitudinal mode out of the oscillation longitudinal modes of said mode-locked laser diode from said continuous wave light output light source in a range where optical injection locking phenomena can be generated;
(b3) adjusting the position of the longitudinal mode of said mode-locked laser diode by applying reverse bias voltage to the p-i-n junction created including said passive wave-guiding area so that the wavelength of said continuous wave lights matches the wavelength of one longitudinal mode out of the longitudinal modes of said mode-locked laser diode which is in mode-locked operation;
(D) adjusting the polarization direction of the output light of said continuous wave light output light source by said polarization plane adjustment element so that the polarization direction of the output light of said continuous wave light output light source in said optical wave guide of said mode-locked laser diode matches the polarization direction of the oscillation light of said mode-locked laser diode, and inputting said output light to said optical wave guide of said mode-locked laser diode;
(E) adjusting the intensity of the continuous wave lights to be input to said optical wave guide of said mode-locked laser diode from said continuous wave light output light source so that the mode-locked optical pulses, of which the wavelength is the same as that of the output lights of said continuous wave light output light source, of which frequency chirping is suppressed, and of which phase noise is low, are output from said mode-locked laser diode; and
(F) outputting the optical pulses from said mode-locked laser diode.

16. A method for controlling the wavelength of optical pulses to be output by the mode-locked laser diode according to claim 14, comprising the steps of:
(A) oscillating said mode-locked laser diode;
(b1) implementing mode-locking operation of said mode-locked laser diode by performing optical modulation at a frequency obtained by multiplying a cyclic frequency of a resonator of said mode-locked laser diode by a natural number in said optical modulation area;
(C) outputting continuous wave lights with wavelength close to the wavelength of one longitudinal mode out of the oscillation longitudinal modes of said mode-locked laser diode from said continuous wave light output light source in a range where optical injection locking phenomena can be generated;
(b3) adjusting the position of the longitudinal mode of said mode-locked laser diode by applying reverse bias voltage to the p-i-n junction created including said passive wave-guiding area so that the wavelength of said continuous wave lights matches the wavelength of one longitudinal mode out of the longitudinal modes of said mode-locked laser diode which is in mode-locked operation;
(D) adjusting the polarization direction of the output light of said continuous wave light output light source by said polarization plane adjustment element so that the polarization direction of the output light of said continuous wave light output light source in said optical wave guide of said mode-locked laser diode matches the polarization direction of the oscillation light of said mode-locked laser diode, and inputting said output light to said optical wave guide of said mode-locked laser diode;
(E) adjusting the intensity of the continuous wave lights to be input to said optical wave guide of said mode-locked laser diode from said continuous wave light output light source so that the mode-locked optical pulses, of which the wavelength is the same as that of the output lights of said continuous wave light output light source, of which frequency chirping is suppressed, and of which phase noise is low, are output from said mode-locked laser diode; and
(F) outputting the optical pulses from said mode-locked laser diode.

17. The mode-locked laser diode device according to claim 2, wherein said oscillation wavelength adjustment means is passive wave-guiding area temperature control means for controlling the temperature of said passive wave-guiding area.

18. The mode-locked laser diode device according to claim 4, wherein said oscillation wavelength adjustment means is passive wave-guiding area temperature control means for controlling the temperature of said passive wave-guiding area.

19. A method for controlling the wavelength of optical pulses to be output by the mode-locked laser diode according to claim 17, comprising the steps of:
(A) oscillating said mode-locked laser diode;
(b1) implementing mode-locking operation of said mode-locked laser diode by performing optical modulation at a frequency obtained by multiplying a cyclic frequency of a resonator of said mode-locked laser diode by a natural number in said optical modulation area;
(C) outputting continuous wave lights with wavelength close to the wavelength of one longitudinal mode out of the oscillation longitudinal modes of said mode-locked laser diode from said continuous wave light output light source in a range where optical injection locking phenomena can be generated;
(b4) adjusting the position of the longitudinal mode by controlling the temperature of said passive wave-guiding area using passive wave-guiding area temperature control means so that the wavelength of said continuous wave lights matches the wavelength of one longitudinal mode out of the longitudinal modes of said mode-locked laser diode which is in mode-locked operation;
(D) adjusting the polarization direction of the output light of said continuous wave light output light source by said polarization plane adjustment element so that the polarization direction of the output light of said continuous wave light output light source in said optical wave guide of said mode-locked laser diode matches the polarization direction of the oscillation light of said mode-locked laser diode, and inputting said output light to said optical wave guide of said mode-locked laser diode;
(E) adjusting the intensity of the continuous wave lights to be input to said optical wave guide of said mode-locked laser diode from said continuous wave light output light source so that the mode-locked optical pulses, of which the wavelength is the same as that of the output lights of said continuous wave light output light source, of which frequency chirping is suppressed, and of which phase noise is low, are output from said mode-locked laser diode; and
(F) outputting the optical pulses from said mode-locked laser diode.

20. A method for controlling the wavelength of optical pulses to be output by the mode-locked laser diode according to claim 18, comprising the steps of:
(A) oscillating said mode-locked laser diode;
(b1) implementing mode-locking operation of said mode-locked laser diode by performing optical modulation at a frequency obtained by multiplying a cyclic frequency of a resonator of said mode-locked laser diode by a natural number in said optical modulation area;
(C) outputting continuous wave lights with wavelength close to the wavelength of one longitudinal mode out of the oscillation longitudinal modes of said mode-locked laser diode from said continuous wave light output light source in a range where optical injection locking phenomena can be generated;
(b4) adjusting the position of the longitudinal mode by controlling the temperature of said passive wave-guiding area using passive wave-guiding area temperature control means so that the wavelength of said continuous wave lights matches the wavelength of one longitudinal mode out of the longitudinal modes of said mode-locked laser diode which is in mode-locked operation;
(D) adjusting the polarization direction of the output light of said continuous wave light output light source by said polarization plane adjustment element so that the polarization direction of the output light of said continuous wave light output light source in said optical wave guide of said mode-locked laser diode matches the polarization direction of the oscillation light of said mode-locked laser diode, and inputting said output light to said optical wave guide of said mode-locked laser diode;
(E) adjusting the intensity of the continuous wave lights to be input to said optical wave guide of said mode-locked laser diode from said continuous wave light output light source so that the mode-locked optical pulses, of which the wavelength is the same as that of the output lights of said continuous wave light output light source, of which frequency chirping is suppressed, and of which phase noise is low, are output from said mode-locked laser diode; and
(F) outputting the optical pulses from said mode-locked laser diode.
